(19) United States
(12) Patent Application Publication
(10) Pub. No.: US 2016/0170474 A1
(43) Pub. Date: Jun. 16, 2016

(54) POWER-SAVING CONTROL SYSTEM, CONTROL DEVICE, CONTROL METHOD, AND CONTROL PROGRAM FOR SERVER EQUIPPED WITH NON-VOLATILE MEMORY

(71) Applicant: NEC CORPORATION, Tokyo (JP)

(72) Inventor: TOSHINORI TAKEMURA, Tokyo (JP)

(21) Appl. No.: 14/904,773

(22) PCT Filed: Jul. 22, 2014
(86) PCT No.: PCT/JP2014/003848

§ 371 Date: Jan. 13, 2016

(30) Foreign Application Priority Data
Aug. 2, 2013 (JP) 2013-161302
Aug. 2, 2013 (JP) 2013-161303
Aug. 2, 2013 (JP) 2013-161304

(51) Int. Cl. G06F 1/32; G06F 9/50; G06F 9/48

(52) U.S. Cl. CPC G06F 1/3287; G06F 9/4893; G06F 9/5094

(57) ABSTRACT

In order to provide normally-off computing with an enhanced power-saving effect for a server equipped with a non-volatile memory, the power-saving control system includes a physical machine that includes a memory and a CPU including a plurality of CPU cores, an operating system that operates on the physical machine, and one or more processes that operate on the operating system, and the operating system includes a process characteristic collection unit that collects a characteristic of the process, a core allocation determination unit that determines allocation of the CPU core to the process in accordance with the characteristic of the process, and a process scheduler that executes the process in accordance with the allocation of the CPU core. Further, the operating system reduces OFF/ON frequency and extends OFF time by powering OFF/ON the CPU core or the memory, in accordance with execution of the process.

### TECHNICAL FIELD

The present invention relates to a technology that enhances a power-saving effect in a server equipped with a non-volatile memory.

### BACKGROUND ART

In recent years, practical application of a universal memory, such as a non-volatile memory integrating a DRAM (Dynamic Random Access Memory) work memory and a NAND storage memory, is becoming widespread. Consequently, research on practical application of a power-saving computer called normally-off computing has been started. In normally-off computing, power supply to components other than components that should actually operate is actively shut off even when an entire system is in operation, by enabling a file on a storage to be directly executed on a non-volatile memory without being loaded into a memory.

A target of such research is to enhance a power-saving effect by making a power-OFF period of a CPU (Central Processing Unit) and a memory as long as possible. Technologies currently under research mainly focus on a hardware layer and an OS (Operating System) layer.

For example, NPL 1 describes a computing technology that realizes normally-off in which power supply to components other than components that should actually operate is actively shut off, even when an entire system is in operation.

### CITATION LIST

### Patent Literature

[PTL 1] Japanese Unexamined Patent Application Publication No. 2010-160565
[PTL 2] Japanese Unexamined Patent Application Publication No. 2010-277171
[PTL 3] Japanese Unexamined Patent Application Publication No. 2012-256263
[PTL 4] Japanese Unexamined Patent Application Publication No. 2012-212257
[PTL 5] Japanese Translation of PCT International Application Publication No. 2005-531860

### Non Patent Literature

[NPL 1] “Normally-off technology aiming for reducing power consumption of computer to 1/10” http://news.mynavi.jp/articles/2013/05/08/noff/index.html

### SUMMARY OF INVENTION

### Technical Problem

According to NPL 1, increase in power consumption due to power-OFF/ON of a CPU circuit and a memory, and power saving due to reduction of leakage current during a power-OFF period offset each other. Therefore, in order to enhance a power-saving effect, it is required to reduce as much power-OFF/ON frequency as possible to extend a continuous power-OFF period. However, there is a limit in extending a continuous power-OFF period by solely relying on skilled power control in hardware and OS layers.

Further, PTL 1 discloses, although being not normally-off computing, a technology that reduces unnecessary power consumption in a multi-core processor system. The technology is a task scheduling device including a scheduler that, when detecting presence of a processor in an idle state, shuts off power supply to such a processor. However, the task scheduling device measures a workload of each task prior to task processing. Furthermore, the device predicts usage ratios of a plurality of processors in accordance with the measured workloads. Therefore, the technology is accompanied by the complicated processes and is not suitable for normally-off computing that demands instantaneous power-OFF/ON.

Further, PTL 2, PTL 3, PTL 4, and PTL 5 are disclosed as related technologies.

The present invention is made in view of the aforementioned problem and an object of the invention is to realize normally-off computing with an enhanced power-saving effect in a server equipped with a non-volatile memory.

### Solution to Problem

A power-saving control system according to the present invention includes a physical machine that includes a memory and a CPU including a plurality of CPU cores, an operating system that operates on the physical machine, and one or more processes that operate on the operating system, wherein the operating system includes a process characteristic collection unit that collects a characteristic of the process, a core allocation determination unit that determines allocation of the CPU core to the process, in accordance with the characteristic of the process, and a process scheduler that executes the process, in accordance with the allocation, and powers OFF/ON the CPU core or the memory, in accordance with execution of the process.

A power-saving control device according to the present invention includes a physical machine that includes a memory and a CPU including a plurality of CPU cores, an operating system unit that operates on the physical machine, and one or more process units operated by the operating system unit, wherein the operating system unit includes a process characteristic collection unit that collects a characteristic of the process unit, a core allocation determination unit that determines allocation of the CPU core to the process unit, in accordance with the characteristic of the process unit, and a process scheduler that executes the process unit, in accordance with the allocation, and powers OFF/ON the CPU core or the memory, in accordance with execution of the process unit.

A power-saving control method according to the present invention is a power-saving control method of a power-saving control system that includes a physical machine including a memory and a CPU including a plurality of CPU cores, an operating system operating on the physical machine, and one or more processes operating on the operating system, wherein the operating system collects a characteristic of the process, determines allocation of the CPU core to the process, in accordance with the characteristic of the process, executes the process, in accordance with the allocation, and powers OFF/ON the CPU core or the memory, in accordance with execution of the process.

A power-saving control program according to the present invention is a power-saving control program of a power-saving control system that includes a physical machine including a memory and a CPU including a plurality of CPU cores, an operating system operating on the physical machine, and one or more processes operating on the operating system, wherein the program causes the operating system to execute processing of collecting a characteristic of the process, processing of determining allocation of the CPU core to the process, in accordance with the characteristic of the process, processing of executing the process, in accordance with the allocation, and processing of powering OFF/ON the CPU core or the memory, in accordance with execution of the process.

A power-saving control system according to the present invention includes a physical machine that includes a memory and a CPU including a plurality of CPU cores, an operating system that operates on the physical machine, and one or more processes that operate on the operating system, wherein the operating system includes a process characteristic collection unit that collects a load characteristic of the process or an interrupt characteristic of the process, an interrupt coalescing unit that coalesces interrupts to the process, in accordance with the load characteristic or the interrupt characteristic, and a process scheduler that executes interrupts in accordance with coalescing of the interrupts, and powers OFF/ON the CPU core or the memory in accordance with execution of the interrupt.

A power-saving control device according to the present invention includes a physical machine that includes a memory and a CPU including a plurality of CPU cores, an operating system unit that operates on the physical machine, and one or more process units that operate on the operating system, wherein the operating system unit includes a process characteristic collection unit that collects a load characteristic of the process unit or an interrupt characteristic of the process unit, an interrupt coalescing unit that coalesces interrupts to the process unit, in accordance with the load characteristic or the interrupt characteristic, and a process scheduler that executes interrupts, in accordance with coalescing of the interrupts, and powers OFF/ON the CPU core or the memory, in accordance with execution of the interrupt.

A power-saving control method according to the present invention is a power-saving control method of a power-saving control system that includes a physical machine including a memory and a CPU including a plurality of CPU cores, an operating system operating on the physical machine, and one or more processes operating on the operating system, wherein the operating system collects a load characteristic of the process or an interrupt characteristic of the process, coalesces interrupts to the process, in accordance with the load characteristic or the interrupt characteristic, executes interrupts, in accordance with coalescing of the interrupts, and powers OFF/ON the CPU core or the memory, in accordance with execution of the interrupt.

A power-saving control program according to the present invention is a power-saving control program of a power-saving control system that includes a physical machine including a memory and a CPU including a plurality of CPU cores, an operating system operating on the physical machine, and one or more processes operating on the operating system, wherein the program causes the operating system to execute processing of collecting a load characteristic of the process or an interrupt characteristic of the process, processing of coalescing interrupts to the process, in accordance with the load characteristic or the interrupt characteristic, processing of executing an interrupt, in accordance with coalescing of the interrupts, and processing of powering OFF/ON the CPU core or the memory, in accordance with execution of the interrupt.

A power-saving control system according to the present invention includes a physical machine that includes a CPU and a memory, an operating system that operates on the physical machine, and one or more processes that operate on the operating system, wherein the operating system includes a process scheduler that performs scheduling of the process, and a memory power control unit that powers ON/OFF the memory, in accordance with the scheduling.

A power-saving control device according to the present invention includes a physical machine that includes a CPU and a memory, an operating system unit that operates on the physical machine, and one or more process units operated by the operating system unit, wherein the operating system unit includes a process scheduler that performs scheduling of the process unit, and a memory power control unit that powers ON/OFF the memory, in accordance with the scheduling.

A power-saving control method according to the present invention is a power-saving control method of a power-saving control system that includes a physical machine including a CPU and a memory, an operating system operating on the physical machine, and one or more processes operating on the operating system, wherein the operating system performs scheduling of the process and powers ON/OFF the memory, in accordance with the scheduling.

A power-saving control program according to the present invention is a power-saving control program of a power-saving control system that includes a physical machine including a CPU and a memory, an operating system operating on the physical machine, and one or more processes operating on the operating system, wherein the program causes the operating system to execute processing of scheduling the process, and processing of powering ON/OFF the memory, in accordance with the scheduling.

### Advantageous Effects of Invention

The present invention is able to provide normally-off computing with an enhanced power-saving effect in a server equipped with a non-volatile memory.

### BRIEF DESCRIPTION OF DRAWINGS

FIG. 1 is a block diagram illustrating a configuration of a power-saving control system according to a first exemplary embodiment of the present invention.

FIG. 2 is a block diagram illustrating a configuration of a power-saving control system according to second, fourth, sixth, and eighth exemplary embodiments of the present invention.

FIG. 3 is a flowchart illustrating an operation of the power-saving control system according to the second, fourth, sixth, and eighth exemplary embodiments of the present invention.

FIG. 4 is a block diagram illustrating a configuration of a power-saving control system according to third, fifth, seventh, and ninth exemplary embodiments of the present invention.

FIG. 5 is a flowchart illustrating an operation of the power-saving control system according to the third, fifth, seventh, and ninth exemplary embodiments of the present invention.

FIG. 6 is a block diagram illustrating a configuration of a power-saving control system according to tenth and twelfth exemplary embodiments of the present invention.

FIG. 7 is a flowchart illustrating an operation of the power-saving control system according to the tenth and twelfth exemplary embodiments of the present invention.

FIG. 8 is a block diagram illustrating a configuration of a power-saving control system according to eleventh and thirteenth exemplary embodiments of the present invention.

FIG. 9 is a flowchart illustrating an operation of the power-saving control system according to the eleventh and thirteenth exemplary embodiments of the present invention.

FIG. 10 is a block diagram illustrating a configuration of a power-saving control system according to a fourteenth exemplary embodiment of the present invention.

FIG. 11 is a flowchart illustrating an operation of the power-saving control system according to the fourteenth exemplary embodiment of the present invention.

FIG. 12 is a block diagram illustrating a configuration of a power-saving control system according to a fifteenth exemplary embodiment of the present invention.

FIG. 13 is a flowchart illustrating an operation of the power-saving control system according to the fifteenth exemplary embodiment of the present invention.

FIG. 14 is a block diagram illustrating a configuration of a power-saving control system according to sixteenth and eighteenth exemplary embodiments of the present invention.

FIG. 15 is a flowchart illustrating an operation of the power-saving control system according to the sixteenth exemplary embodiment of the present invention.

FIG. 16 is a block diagram illustrating a configuration of a power-saving control system according to seventeenth and nineteenth exemplary embodiments of the present invention.

FIG. 17 is a flowchart illustrating an operation of the power-saving control system according to the seventeenth exemplary embodiment of the present invention.

### DESCRIPTION OF EMBODIMENTS

Exemplary embodiments of the present invention will be described in detail below with reference to the drawings. Although technically preferred limitations for implementing the present invention are applied to the exemplary embodiments described below, the scope of the invention is not limited thereto.

### First Exemplary Embodiment

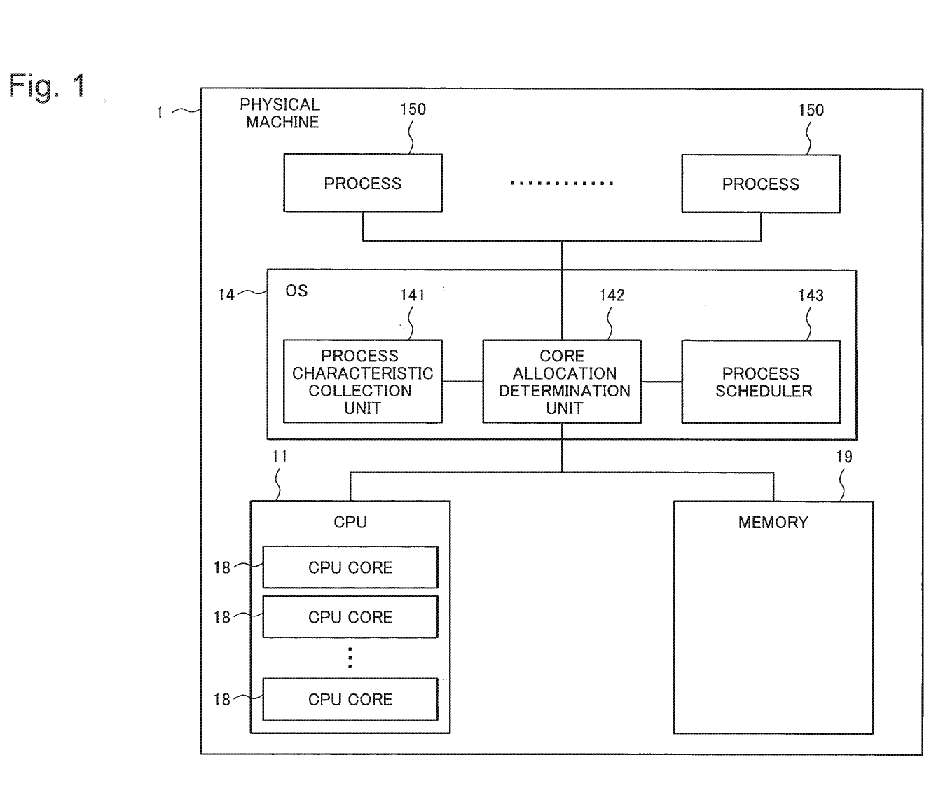

FIG. 1 is a block diagram illustrating a configuration of a power-saving control system for a server equipped with a non-volatile memory according to a first exemplary embodiment of the present invention. The power-saving control system according to the present exemplary embodiment includes a physical machine 1 that includes a memory 19 and a CPU 11 including a plurality of CPU cores 18, an operating system 14 that operates on the physical machine 1, and one or more processes 150 that operate on the operating system 14. The operating system 14 includes a process characteristic collection unit 141 that collects a characteristic of the process 150. Further, the operating system 14 includes a core allocation determination unit 142 that determines allocation of the CPU core 18 to the process 150, in accordance with the characteristic of the process 150, and a process scheduler 143 that executes the process 150, in accordance with the allocation. Further, the operating system 14 powers OFF/ON the CPU core 18 or the memory 19, in accordance with execution of the process 150.

The present exemplary embodiment is able to provide normally-off computing with an enhanced power-saving effect in a server equipped with a non-volatile memory.

### Second Exemplary Embodiment

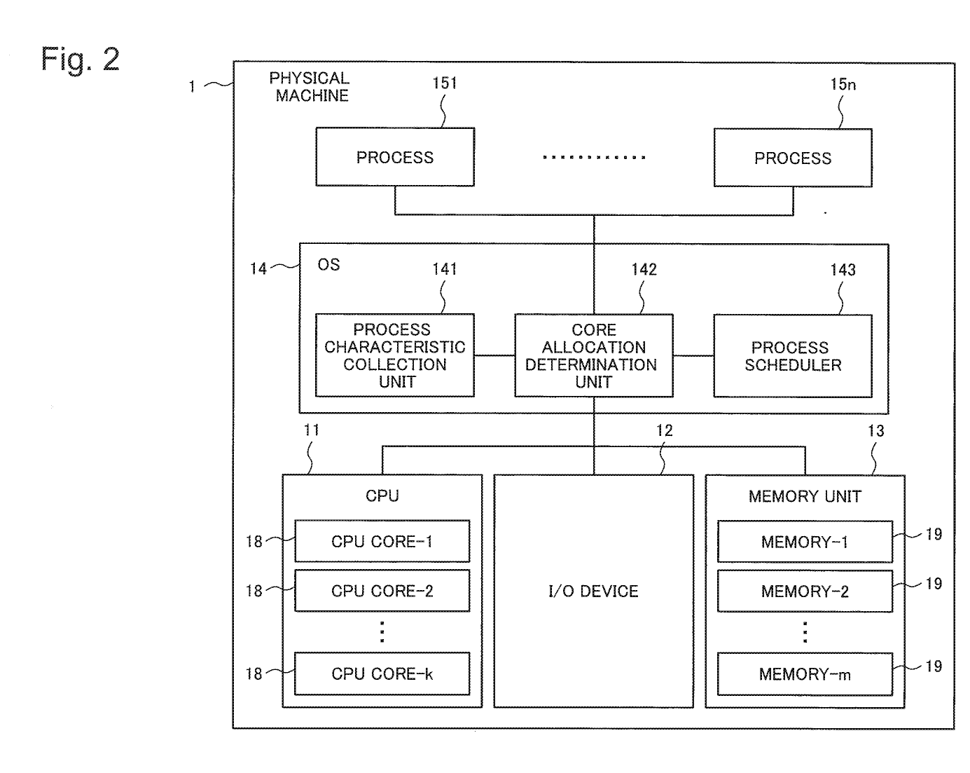

FIG. 2 is a block diagram illustrating a configuration of a power-saving control system for a server equipped with a non-volatile memory according to a second exemplary embodiment of the present invention. The power-saving control system according to the present exemplary embodiment includes a physical machine 1. The physical machine 1 includes a CPU 11 including a plurality of CPU cores 18 (k cores in FIG. 2, where k is a positive integer greater than or equal to 2), an I/O device 12 (Input/Output device), and a memory unit 13 including one or more memories 19 (m memories in FIG. 2, where m is a positive integer). Further, the physical machine 1 includes an OS 14 (Operating System) that operates on the CPU 11, the I/O device 12, and the memory unit 13. The OS 14 includes a process characteristic collection unit 141, a core allocation determination unit 142, and a process scheduler 143. Further, processes 151 to 15n (where n is a positive integer) as applications operate on the OS 14.

The CPU 11 includes a plurality of CPU cores 18 and has a function called power gating capable of shutting off power to part of a CPU circuit at any timing, in addition to ordinary CPU processing. The present exemplary embodiment provides power shut-off/resumption control on a per CPU core 18 basis.

The I/O device 12 includes an interface for data exchange with various devices such as a network.

The memory unit 13 includes the memory 19 capable of operating in response to an operation of each CPU core 18. The memory 19 may be a non-volatile memory and power to an unused memory 19 can be shut off. In that case, stored data are not erased and the data can be read after power is resumed.

The memory unit 13 may also be a memory including one or more memory areas. In this case, a memory area corresponds to the memory 19.

As a non-volatile memory, an ReRAM (Resistive RAM), an MRAM (Magnetoresistive RAM), an STT-MRAM (Spin Transfer Torque-MRAM), a PRAM (Phase change RAM), and an FeRAM (Ferroelectric RAM) may be used. Further, any non-volatile memory may be used without limiting to the memories described above.

The OS 14 includes the process characteristic collection unit 141, the core allocation determination unit 142, and the process scheduler 143, and performs process execution control for an enhanced power-saving effect, by shutting off power to the CPU core 18 in the CPU 11 and the memory 19 in the memory unit 13.

The process characteristic collection unit 141 collects information about the processes 151 to 15n, including a load characteristic such as a CPU utilization rate, a cache hit rate, and context switching frequency, and a resource utilization characteristic such as incoming/outgoing network traffic.

The core allocation determination unit 142 determines allocation of which process is to be executed by which CPU core 18, in accordance with the load characteristics and the resource utilization characteristics of the processes 151 to 15n, collected by the process characteristic collection unit 141. The core allocation determination unit 142 monitors a load and resource usage frequency of each process, assembles processes with a low load and low resource usage frequency, and allocates the processes to a same CPU core 18. Similarly, the core allocation determination unit 142 assembles processes with a high load and high resource usage frequency and allocates the processes to a same CPU core 18. In this case, in order to avoid degradation of a processing capability of the CPU core 18, assembling and allocation are performed within an upper limit of the CPU core 18 and the resource. Thus, in a CPU core 18 where low-load processes are assembled, downtime caused by power gating of the CPU can be extended.

The process scheduler 143 performs scheduling of process execution, in accordance with determination made by the core allocation determination unit 142.

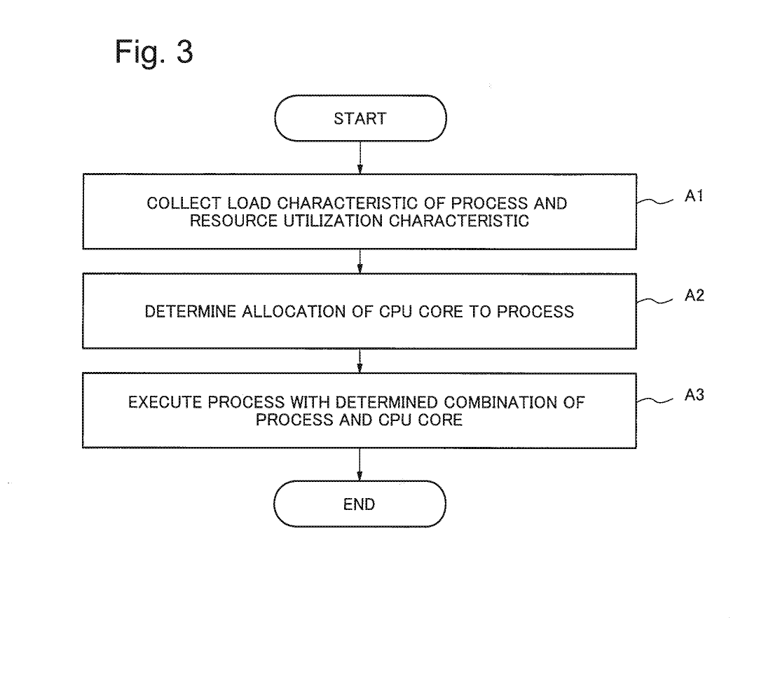

FIG. 3 is a flowchart illustrating a procedure of a power-saving control method of the power-saving control system according to the present exemplary embodiment illustrated in FIG. 2.

The process characteristic collection unit 141 collects load characteristics and resource utilization characteristics of the processes 151 to 15n operating on the physical machine 1 (Step A1).

Next, the core allocation determination unit 142 determines allocation of which process is to be executed by which CPU core 18, in accordance with the process characteristics collected by the process characteristic collection unit 141 (Step A2).

A CPU utilization rate of each process is used as a criterion here, and processes are allocated to the CPU core 18 in descending order of CPU utilization rates, within a range not exceeding an upper limit of the CPU utilization rate. Therefore, an algorithm such as the best-fit algorithm in the bin packing problem may be used without limiting to a specific algorithm. Thus, in a CPU core 18 where low-load processes are assembled, downtime caused by power gating of the CPU 11 can be extended.

Further, determination and allocation can be made by use of an instantaneous value of a CPU utilization rate, without performing processing time measurement or workload prediction of each process. Thus, instantaneous power-OFF/ON corresponding to normally-off computing can be provided without performing a complicated process.

Next, in accordance with association between each process and a CPU core 18 determined by the core allocation determination unit 142, the process scheduler 143 controls execution of processes (Step A3).

At this time, power-OFF/ON of a CPU core 18 and a memory 19 working with the CPU core 18 is automatically controlled by the power gating function of the CPU 11. In other words, even when an entire system is in operation, components other than components such as a CPU core 18 and a memory 19 that should actually operate at the moment can be powered OFF, and components such as a CPU core 18 and a memory 19 that should actually operate can be powered ON.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

A power-saving control device according to the present exemplary embodiment is a power-saving control device that has a configuration of the physical machine 1 in FIG. 2. Further, a power-saving control program according to the present exemplary embodiment is a power-saving control program that causes execution of the flowchart in FIG. 3.

The present exemplary embodiment provides extended idle time for a CPU core allocated with a process with a low CPU utilization rate, and therefore long and continuous downtime of the CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Third Exemplary Embodiment

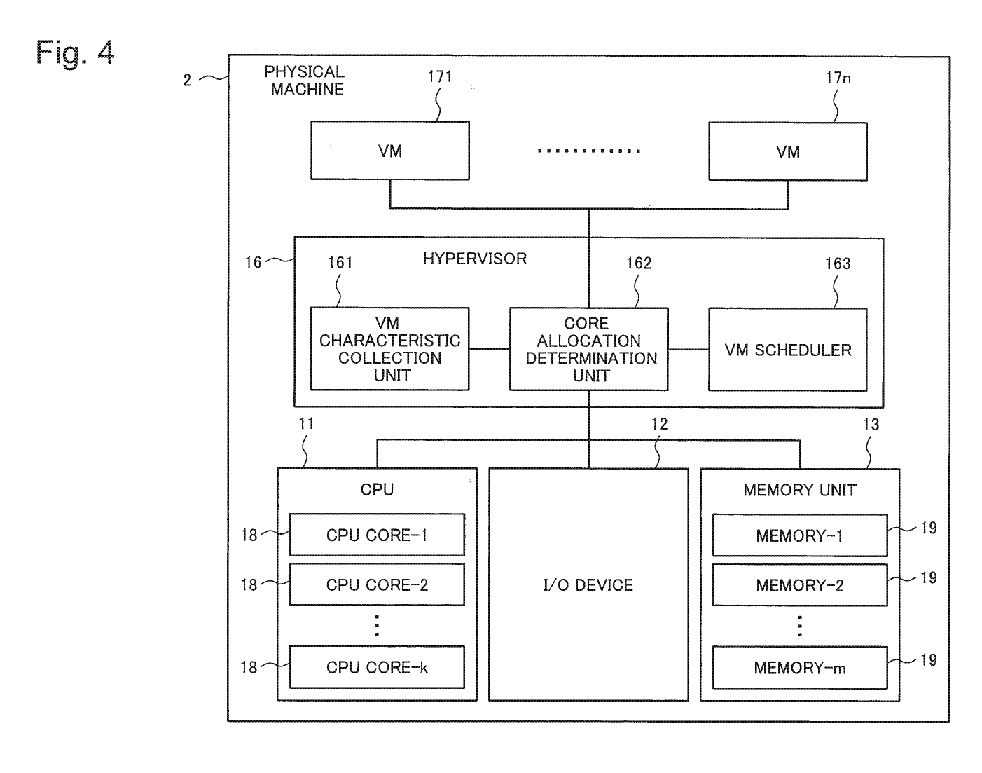

FIG. 4 is a block diagram illustrating a configuration of a power-saving control system according to a third exemplary embodiment of the present invention. The power-saving control system according to the present exemplary embodiment is a physical machine 2 obtained by virtualizing the interior of the physical machine 1 in FIG. 2 by a hypervisor 16, and is different from the power-saving system according to the second exemplary embodiment in that a plurality of virtual machines (VMs) 171 to 17n operate on the hypervisor 16. In FIG. 4, VMs operating on the hypervisor 16 are given reference signs 171 to 17n (where n is a positive integer) and distinguished.

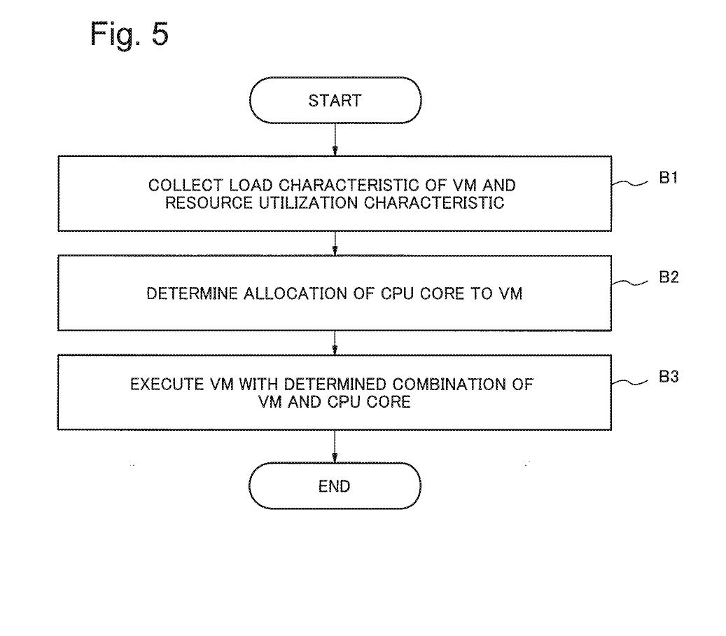

FIG. 5 is a flowchart illustrating a procedure of a power-saving control method of the power-saving control system according to the present exemplary embodiment illustrated in FIG. 4. In this power-saving control system, an enhanced power-saving effect is provided by skilled VM scheduling.

As illustrated in FIGS. 4 and 5, a VM characteristic collection unit 161 collects load characteristics and resource utilization characteristics of the VMs 171 to 17n operating on the physical machine 2 (Step B1).

Next, a core allocation determination unit 162 determines allocation of which VM is to be executed by which CPU core 18, in accordance with the VM characteristics collected by the VM characteristic collection unit 161 (Step B2).

A CPU utilization rate of each VM is used as a criterion here, and VMs are allocated to a few CPU cores 18 in descending order of CPU utilization rates, within a range not exceeding an upper limit of the CPU utilization rate. Therefore, an algorithm such as the best-fit algorithm in the bin packing problem may be used without limiting to a specific algorithm. Thus, in a CPU core 18 where low-load VMs are assembled, downtime caused by power gating of the CPU can be extended.

Further, determination and allocation can be made by use of an instantaneous value of a CPU utilization rate, without performing processing time measurement or workload prediction of each process. Thus, instantaneous power-OFF/ON corresponding to normally-off computing can be provided without performing a complicated process.

Next, in accordance with association between each VM and a CPU core determined by the core allocation determination unit 162, the VM scheduler 163 controls execution of VMs (Step B3).

At this time, power-OFF/ON of a CPU core 18 and a memory 19 is automatically controlled by the power gating function of the CPU 11. In other words, even when an entire system is in operation, components other than components such as a CPU core 18 and a memory 19 that should actually operate at the moment can be powered OFF, and components such as a CPU core 18 and a memory 19 that should actually operate can be powered ON.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

A power-saving control device according to the present exemplary embodiment is a power-saving control device that has a configuration of the physical machine 2 in FIG. 4. Further, a power-saving control program according to the present exemplary embodiment is a power-saving control program that causes execution of the flowchart in FIG. 5.

The present exemplary embodiment provides extended idle time for a CPU core allocated with a VM with a low CPU utilization rate, and therefore long and continuous downtime of the CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Fourth Exemplary Embodiment

Next, a fourth exemplary embodiment of the present invention will be described. The fourth exemplary embodiment of the present invention has a configuration of the physical machine 1 illustrated in FIG. 2. The fourth exemplary embodiment is different from the second exemplary embodiment in that, in the process allocation method in the core allocation determination unit 142 in FIG. 2, allocation is made so as to level usage frequency as much as possible, instead of coalescing processes with high usage frequency.

A flowchart illustrating a procedure of a power-saving control method according to the present exemplary embodiment will be described by use of FIG. 3.

Step A1 in FIG. 3 is the same processing as the second exemplary embodiment.

In Step A2 in FIG. 3, the core allocation determination unit 142 determines allocation of which process is to be executed by which CPU core 18, in accordance with the load characteristics and the resource utilization characteristics of the processes 151 to 15n, collected in Step A1. A CPU utilization rate of each process is used as a criterion here, and each process is allocated to a CPU core 18 so that the sum of CPU utilization rates of processes allocated to each CPU core 18 is as equalized as possible on a per CPU core 18 basis. In other words, each process is allocated to a CPU core 18 so as to minimize the difference of CPU utilization rates between CPU cores 18.

Step A3 in FIG. 3 is the same processing as the second exemplary embodiment.

A power-saving control device according to the present exemplary embodiment is a power-saving control device that has a configuration of the physical machine 1 in FIG. 2. Further, a power-saving control program according to the present exemplary embodiment is a power-saving control program that causes execution of the flowchart in FIG. 3.

The present exemplary embodiment provides a similar amount of idle time for each CPU core, and therefore downtime of a CPU core and a memory working therewith due to power shut-off can be evenly secured from all CPU cores. Thus, an enhanced power-saving effect can be obtained.

As described above, the present exemplary embodiment is able to provide normally-off computing with an enhanced power-saving effect in a server equipped with a non-volatile memory.

### Fifth Exemplary Embodiment

Next, a fifth exemplary embodiment of the present invention will be described. The fifth exemplary embodiment of the present invention has a configuration of the physical machine 2 illustrated in FIG. 4. The fifth exemplary embodiment is different from the third exemplary embodiment in that, in the VM allocation method in the core allocation determination unit 162 in FIG. 4, allocation is made so as to level usage frequency as much as possible, instead of coalescing VMs with high usage frequency.

A flowchart illustrating a procedure of a power-saving control method according to the present exemplary embodiment will be described by use of FIG. 5.

Step B1 in FIG. 5 is the same processing as the second exemplary embodiment.

In Step B2 in FIG. 5, the core allocation determination unit 162 determines allocation of which VM is to be executed by which CPU core 18, in accordance with the load characteristics and the resource utilization characteristics of the VMs 171 to 17n, collected in Step B1. A CPU utilization rate of each VM is used as a criterion here, and each VM is allocated to a CPU core 18 so that the sum of CPU utilization rates of VMs allocated to a CPU core 18 is as equalized as possible on a per CPU core 18 basis. In other words, each VM is allocated to a CPU core 18 so as to minimize the difference of CPU utilization rates between CPU cores 18.

Step B3 in FIG. 5 is the same processing as the third exemplary embodiment.

A power-saving control device according to the present exemplary embodiment is a power-saving control device that has a configuration of the physical machine 2 in FIG. 4. Further, a power-saving control program according to the present exemplary embodiment is a power-saving control program that causes execution of the flowchart in FIG. 5.

The present exemplary embodiment provides a similar amount of idle time for each CPU core, and therefore downtime of a CPU core and a memory working therewith due to power shut-off can be evenly secured from all CPU cores. Thus, an enhanced power-saving effect can be obtained.

As described above, the present exemplary embodiment is able to provide normally-off computing with an enhanced power-saving effect in a server equipped with a non-volatile memory.

### Sixth Exemplary Embodiment

Next, a sixth exemplary embodiment of the present invention will be described. The sixth exemplary embodiment of the present invention has a configuration of the physical machine 1 illustrated in FIG. 2. The sixth exemplary embodiment is different from the second exemplary embodiment in that, in the process allocation method in the core allocation determination unit 142 in FIG. 2, context switching frequency of a process is used as a criterion, instead of usage frequency such as a CPU utilization rate of each process.

A flowchart illustrating a procedure of a power-saving control method according to the present exemplary embodiment will be described by use of FIG. 3.

Step A1 in FIG. 3 is the same processing as the second exemplary embodiment.

In Step A2 in FIG. 3, the core allocation determination unit 142 determines allocation of which process is to be executed by which CPU core 18, in accordance with the load characteristics and the resource utilization characteristics of the processes 151 to 15n, collected in Step A1. Context switching frequency of each process is used as a criterion here, and processes are allocated to a CPU core 18 in descending order of context switching frequency, within a range not exceeding an upper limit of context switching frequency.

Step A3 in FIG. 3 is the same processing as the second exemplary embodiment.

A power-saving control device according to the present exemplary embodiment is a power-saving control device that has a configuration of the physical machine 1 in FIG. 2. Further, a power-saving control program according to the present exemplary embodiment is a power-saving control program that causes execution of the flowchart in FIG. 3.

The present exemplary embodiment provides extended idle time for a CPU core allocated with a process with low context switching frequency, and therefore long and continuous downtime of the CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Seventh Exemplary Embodiment

Next, a seventh exemplary embodiment of the present invention will be described. The seventh exemplary embodiment of the present invention has a configuration of the physical machine 2 illustrated in FIG. 4. The seventh exemplary embodiment is different from the third exemplary embodiment in that, in the VM allocation method in the core allocation determination unit 162 in FIG. 4, context switching frequency of a VM is used as a criterion, instead of usage frequency such as a CPU utilization rate of each VM.

A flowchart illustrating a procedure of a power-saving control method according to the present exemplary embodiment will be described by use of FIG. 5.

Step B1 in FIG. 5 is the same processing as the third exemplary embodiment.

In Step B2 in FIG. 5, the core allocation determination unit 162 determines allocation of which VM is to be executed by which CPU core 18, in accordance with the load characteristics and the resource utilization characteristics of the VMs 171 to 17n, collected in Step B1. Context switching frequency of each VM is used as a criterion here, and VMs are allocated to a CPU core 18 in descending order of context switching frequency, within a range not exceeding an upper limit of context switching frequency.

Step B3 in FIG. 5 is the same processing as the third exemplary embodiment.

A power-saving control device according to the present exemplary embodiment is a power-saving control device that has a configuration of the physical machine 2 in FIG. 4. Further, a power-saving control program according to the present exemplary embodiment is a power-saving control program that causes execution of the flowchart in FIG. 5.

The present exemplary embodiment provides extended idle time for a CPU core allocated with a VM with low context switching frequency, and therefore long and continuous downtime of the CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Eighth Exemplary Embodiment

Next, an eighth exemplary embodiment of the present invention will be described. The eighth exemplary embodiment of the present invention has a configuration of the physical machine 1 illustrated in FIG. 2. The eighth exemplary embodiment is different from the sixth exemplary embodiment in that, in the process allocation method in the core allocation determination unit 142 in FIG. 2, allocation is made so as to level context switching frequency of a process as much as possible, instead of coalescing processes with high context switching frequency.

A flowchart illustrating a procedure of a power-saving control method according to the present exemplary embodiment will be described by use of FIG. 3.

Step A1 in FIG. 3 is the same processing as the sixth exemplary embodiment.

In Step A2 in FIG. 3, the core allocation determination unit 142 determines allocation of which process is to be executed by which CPU core 18, in accordance with the load characteristics and the resource utilization characteristics of the processes 151 to 15n, collected in Step A1. Context switching frequency of each process is used as a criterion here, and each process is allocated to a CPU core so that the sum of context switching frequency of processes allocated to a CPU core 18 is as equalized as possible on a per CPU core 18 basis. In other words, each process is allocated to a CPU core so as to minimize the difference of context switching frequency between CPU cores 18.

Step A3 in FIG. 3 is the same processing as the sixth exemplary embodiment.

A power-saving control device according to the present exemplary embodiment is a power-saving control device that has a configuration of the physical machine 1 in FIG. 2. Further, a power-saving control program according to the present exemplary embodiment is a power-saving control program that causes execution of the flowchart in FIG. 3.

The present exemplary embodiment provides a similar amount of idle time for each CPU core, and therefore downtime of a CPU core and a memory working therewith due to power shut-off can be evenly secured from all CPU cores. Thus, an enhanced power-saving effect can be obtained.

As described above, the present exemplary embodiment is able to provide normally-off computing with an enhanced power-saving effect in a server equipped with a non-volatile memory.

### Ninth Exemplary Embodiment

Next, a ninth exemplary embodiment of the present invention will be described in detail. The ninth exemplary embodiment of the present invention has a configuration of the physical machine 2 illustrated in FIG. 4. The ninth exemplary embodiment is different from the seventh exemplary embodiment in that, in the VM allocation method in the core allocation determination unit 162 in FIG. 4, allocation is made so as to level context switching frequency of a VM as much as possible, instead of coalescing VMs with high context switching frequency.

A flowchart illustrating a procedure of a power-saving control method according to the present exemplary embodiment will be described by use of FIG. 5.

Step B1 in FIG. 5 is the same processing as the seventh exemplary embodiment.

In Step B2 in FIG. 5, the core allocation determination unit 162 determines allocation of which VM is to be executed by which CPU core 18, in accordance with the load characteristics and the resource utilization characteristics of the VMs 171 to 17n, collected in Step B1. Context switching frequency of each VM is used as a criterion here, and each VM is allocated to a CPU core 18 so that the sum of context switching frequency of VMs allocated to a CPU core 18 is as equalized as possible on a per CPU core basis. In other words, each VM is allocated to a CPU core 18 so as to minimize the difference of context switching frequency between CPU cores 18.

Step B3 in FIG. 5 is the same processing as the seventh exemplary embodiment.

A power-saving control device according to the present exemplary embodiment is a power-saving control device that has a configuration of the physical machine 2 in FIG. 4. Further, a power-saving control program according to the present exemplary embodiment is a power-saving control program that causes execution of the flowchart in FIG. 5.

The present exemplary embodiment provides a similar amount of idle time for each CPU core, and therefore downtime of a CPU core and a memory working therewith due to power shut-off can be evenly secured from all CPU cores. Thus, an enhanced power-saving effect can be obtained.

As described above, the present exemplary embodiment is able to provide normally-off computing with an enhanced power-saving effect in a server equipped with a non-volatile memory.

### Tenth Exemplary Embodiment

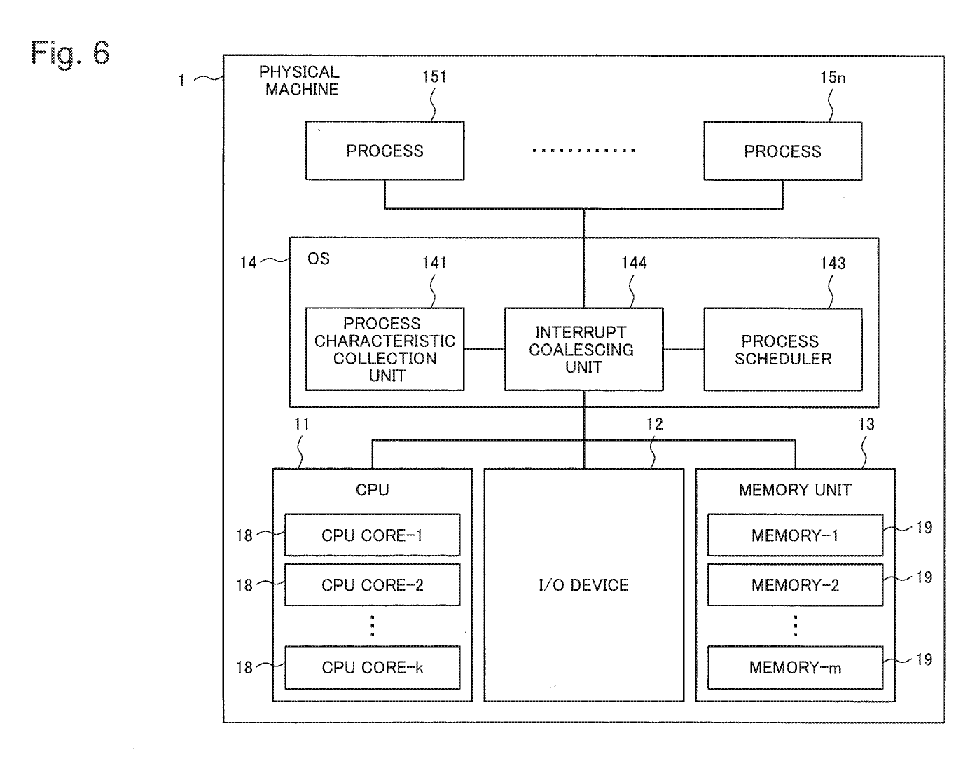

FIG. 6 is a block diagram illustrating a configuration of a power-saving control system for a server equipped with a non-volatile memory according to a tenth exemplary embodiment of the present invention. The power-saving control system according to the present exemplary embodiment includes a physical machine 1, and the physical machine 1 includes a CPU 11 including a plurality of CPU cores 18 (k cores in FIG. 6, where k is a positive integer greater than or equal to 2), an I/O device 12, and a memory unit 13 including one or more memories 19 (m memories in FIG. 6, where m is a positive integer). Further, the physical machine 1 includes an OS 14 that operates on the CPU 11, the I/O device 12, and the memory 13, and the OS 14 includes a process characteristic collection unit 141, an interrupt coalescing unit 144, and a process scheduler 143. Further, processes 151 to 15n (where n is a positive integer) as applications operate on the OS 14.

The CPU 11 includes a plurality of CPU cores 18 and has a function called power gating capable of shutting off power to part of the CPU circuit at any timing, in addition to ordinary CPU processing. The present exemplary embodiment provides power shut-off/resumption control on a per CPU core 18 basis.

The I/O device 12 includes an interface for data exchange with various devices such as a network.

The memory unit 13 includes the memory 19 capable of operating in response to an operation of each CPU core 18. The memory 19 may be a non-volatile memory and power to an unused memory 19 can be shut off. In that case, stored data are not erased and the data can be read after power is resumed.

The memory unit 13 may also be a memory including one or more memory areas. In this case, a memory area corresponds to the memory 19.

As a non-volatile memory, an ReRAM, an MRAM, an STT-MRAM, a PRAM, and an FeRAM may be used. Further, any non-volatile memory may be used without limiting to the memories described above.

The OS 14 includes the process characteristic collection unit 141, the interrupt coalescing unit 144, and the process scheduler 143, and performs process execution control for an enhanced power-saving effect, by shutting off power to the CPU core 18 in the CPU 11 and the memory 19 in the memory unit 13.

The process characteristic collection unit 141 collects information about the processes 151 to 15n, including a load characteristic such as a CPU utilization rate, a cache hit rate, and context switching frequency, and an interrupt characteristic such as frequency of interrupts caused by input/output of a device or the like.

The interrupt coalescing unit 144 coalesces interrupts to a process with a low load characteristic, in accordance with the load characteristics and the interrupt characteristics of the processes 151 to 15n, collected by the process characteristic collection unit 141. The interrupt coalescing unit 144 monitors a load characteristic and interrupt frequency of each process, and coalesces interrupts to a process with low values of such characteristics. Thus, continuous downtime of a CPU core 18 can be extended in a process with low values of a load characteristic and interrupt frequency.

The process scheduler 143 executes interrupts coalesced by the interrupt coalescing unit 144.

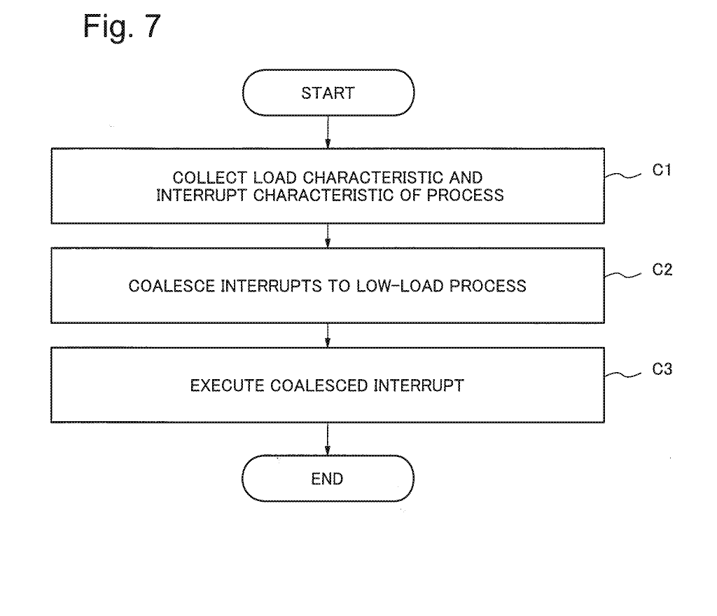

FIG. 7 is a flowchart illustrating a procedure of a power-saving control method of the power-saving control system according to the present exemplary embodiment illustrated in FIG. 6.

The process characteristic collection unit 141 collects load characteristics and interrupt characteristics, i.e. resource utilization characteristics, of the processes 151 to 15n that operate on the physical machine 1 (Step C1).

Next, the interrupt coalescing unit 144 refers to the process characteristics collected by the process characteristic collection unit 141 and coalesces interrupts to a low-load process (Step C2). A CPU utilization rate and interrupt frequency of each process are used as criteria here, and interrupts are coalesced when the characteristic values are lower than predetermined thresholds. Interrupt coalescing is completed when a certain number of interrupts, occurring randomly and stored in a queue, are accumulated, or a certain period of time elapses. Thus, continuous downtime of a CPU core 18 can be extended in a process with a low load and low interrupt frequency.

Next, the process scheduler 143 executes interrupts coalesced by the interrupt coalescing unit 144 (Step C3).

At this time, power-OFF/ON of a CPU core 18 and a memory 19 is automatically controlled by the power gating function of the CPU 11. In other words, even when an entire system is in operation, components other than components such as a CPU core 18 and a memory 19 that should actually operate at the moment can be powered OFF, and components such as a CPU core 18 and a memory 19 that should actually operate can be powered ON.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

A power-saving control device according to the present exemplary embodiment is a power-saving control device that has a configuration of the physical machine 1 in FIG. 6. Further, a power-saving control program according to the present exemplary embodiment is a power-saving control program that causes execution of the flowchart in FIG. 7.

The present exemplary embodiment provides coalescing of interrupts to a process with a low CPU utilization rate and low interrupt frequency, and therefore long and continuous downtime of a CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Eleventh Exemplary Embodiment

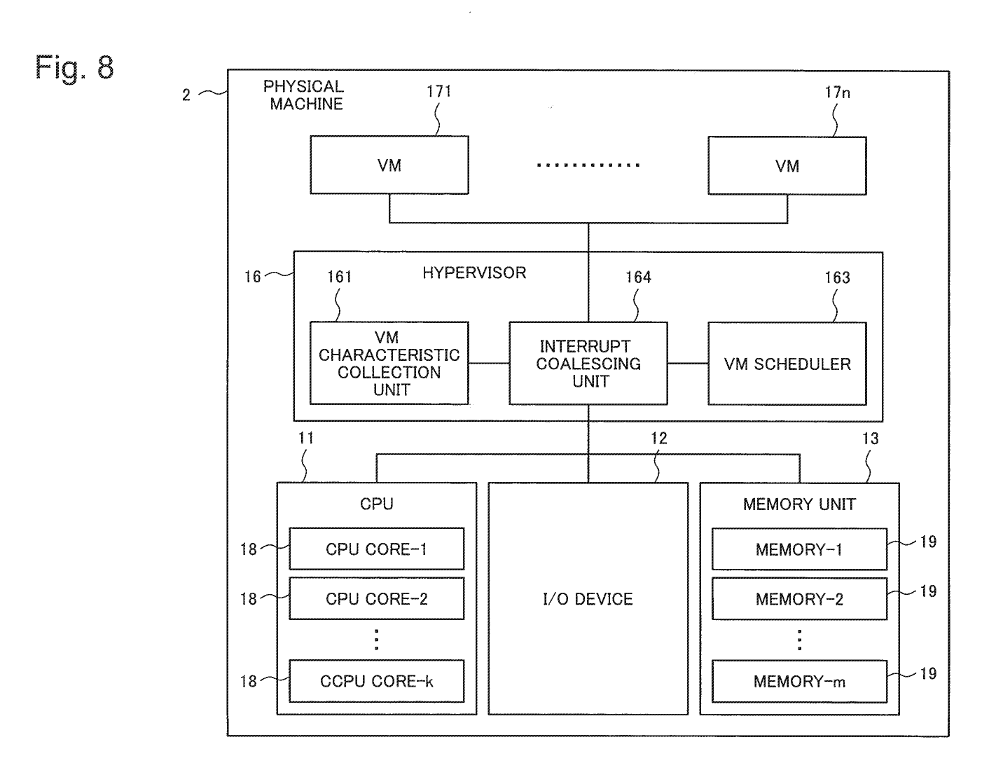

FIG. 8 is a block diagram illustrating a configuration of a power-saving control system according to an eleventh exemplary embodiment of the present invention. The power-saving control system according to the present exemplary embodiment is a physical machine 2 obtained by virtualizing the interior of the physical machine 1 in FIG. 6 by a hypervisor 16, and is different from the power-saving system according to the tenth exemplary embodiment in that a plurality of virtual machines (VMs) 171 to 17n operate on the hypervisor 16. In FIG. 8, VMs operating on the hypervisor 16 are given reference signs 171 to 17n (where n is a positive integer) and distinguished.

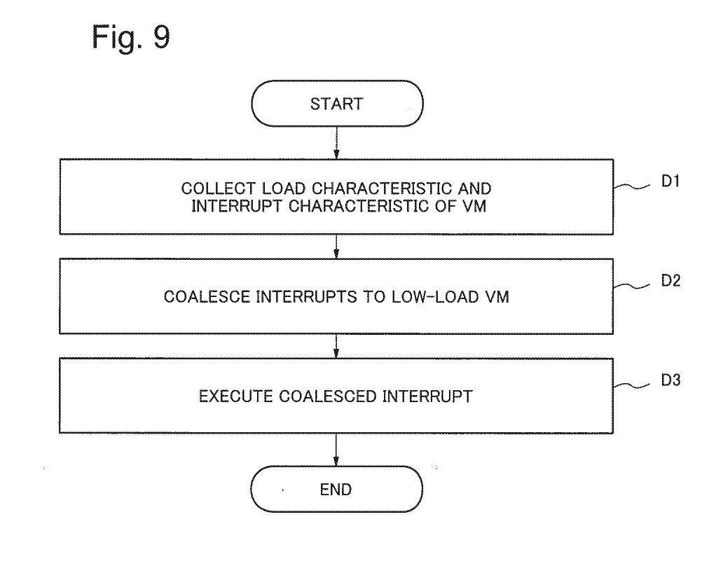

FIG. 9 is a flowchart illustrating a procedure of a power-saving control method of the power-saving control system according to the present exemplary embodiment illustrated in FIG. 8. In this power-saving control system, an enhanced power-saving effect is provided by coalescing interrupts to a low-load VM to extend CPU downtime.

As illustrated in FIGS. 8 and 9, the VM characteristic collection unit 161 collects load characteristics and interrupt characteristics, i.e. resource utilization characteristics, of the VMs 171 to 17n that operate on the physical machine 2 (Step D1).

Next, the interrupt coalescing unit 164 coalesces interrupts to a VM with a low load characteristic, in accordance with the VM characteristics collected by the VM characteristic collection unit 161 (Step D2). A CPU utilization rate and interrupt frequency of each VM are used as criteria here, and interrupts are coalesced when the characteristic values are lower than predetermined thresholds. Interrupt coalescing is completed when a certain number of interrupts, occurring randomly and stored in a queue, are accumulated, or a certain period of time elapses. Thus, continuous downtime of a CPU core 18 can be extended in a VM with a low load and low interrupt frequency.

Next, the VM scheduler 163 executes interrupts coalesced by the interrupt coalescing unit 164 (Step D3).

At this time, power-OFF/ON of a CPU core 18 and a memory 19 is automatically controlled by the power gating function of the CPU 11. In other words, even when an entire system is in operation, components other than components such as a CPU core 18 and a memory 19 that should actually operate at the moment can be powered OFF, and components such as a CPU core 18 and a memory 18 that should actually operate can be powered ON.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

A power-saving control device according to the present exemplary embodiment is a power-saving control device that has a configuration of the physical machine 2 in aforementioned FIG. 8. Further, a power-saving control program according to the present exemplary embodiment is a power-saving control program that causes execution of the flowchart in aforementioned FIG. 9.

The present exemplary embodiment provides coalescing of interrupts to a VM with a low CPU utilization rate and low interrupt frequency, and therefore long and continuous downtime of a CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Twelfth Exemplary Embodiment

Next, a twelfth exemplary embodiment of the present invention will be described. The twelfth exemplary embodiment of the present invention has a configuration of the physical machine 1 illustrated in FIG. 6. The twelfth exemplary embodiment is different from the tenth exemplary embodiment in that, in interrupt coalescing in the interrupt coalescing unit 144 in FIG. 6, interrupts to a low-priority process are coalesced.

A flowchart illustrating a procedure of a power-saving control method according to the present exemplary embodiment will be described by use of FIG. 7.

Step C1 in FIG. 7 is the same processing as the tenth exemplary embodiment. However, process priority is collected as an interrupt characteristic.

In Step C2 in FIG. 7, the interrupt coalescing unit 144 coalesces interrupts to a process with low process priority, in accordance with the load characteristics and the interrupt characteristics of the processes 151 to 15n, collected in Step C1. Execution frequency of a process with low process priority can be reduced when a load on the physical machine 1 becomes high, and therefore preferential coalescing of interrupts to such a process has a low impact.

Step C3 in FIG. 7 is the same processing as the tenth exemplary embodiment.

A power-saving control device according to the present exemplary embodiment is a power-saving control device that has a configuration of the physical machine 1 in FIG. 6. Further, a power-saving control program according to the present exemplary embodiment is a power-saving control program that causes execution of the flowchart in FIG. 7.

The present exemplary embodiment provides coalescing of interrupts to a process with low process priority, and therefore long and continuous downtime of a CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Thirteenth Exemplary Embodiment

Next, a thirteenth exemplary embodiment of the present invention will be described. The thirteenth exemplary embodiment of the present invention has a configuration of the physical machine 2 illustrated in FIG. 8. The thirteenth exemplary embodiment is different from the eleventh exemplary embodiment in that, in interrupt coalescing in the interrupt coalescing unit 164 in FIG. 8, interrupts to a low-priority VM are coalesced.

A flowchart illustrating a procedure of a power-saving control method according to the present exemplary embodiment will be described by use of FIG. 9.

Step D1 in FIG. 9 is the same processing as the eleventh exemplary embodiment. However, VM priority is collected as an interrupt characteristic.

In Step D2 in FIG. 9, the interrupt coalescing unit 164 coalesces interrupts to a VM with low VM priority, in accordance with the load characteristics and the interrupt characteristics of the VMs 171 to 17n, collected in Step D1. Execution frequency of a VM with low VM priority can be reduced when a load on the physical machine 2 becomes high, and therefore preferential coalescing of interrupts to such a VM has a low impact.

Step D3 in FIG. 9 is the same processing as the eleventh exemplary embodiment.

A power-saving control device according to the present exemplary embodiment is a power-saving control device that has a configuration of the physical machine 2 in aforementioned FIG. 8. Further, a power-saving control program according to the present exemplary embodiment is a power-saving control program that causes execution of the flowchart in aforementioned FIG. 9.

The present exemplary embodiment provides coalescing of interrupts to a VM with low VM priority, and therefore long and continuous downtime of a CPU core and a memory working therewith due to power shut-off can be secured. Thus, an enhanced power-saving effect can be obtained.

As described above, the present exemplary embodiment is able to provide normally-off computing with an enhanced power-saving effect in a server equipped with a non-volatile memory.

### Fourteenth Exemplary Embodiment

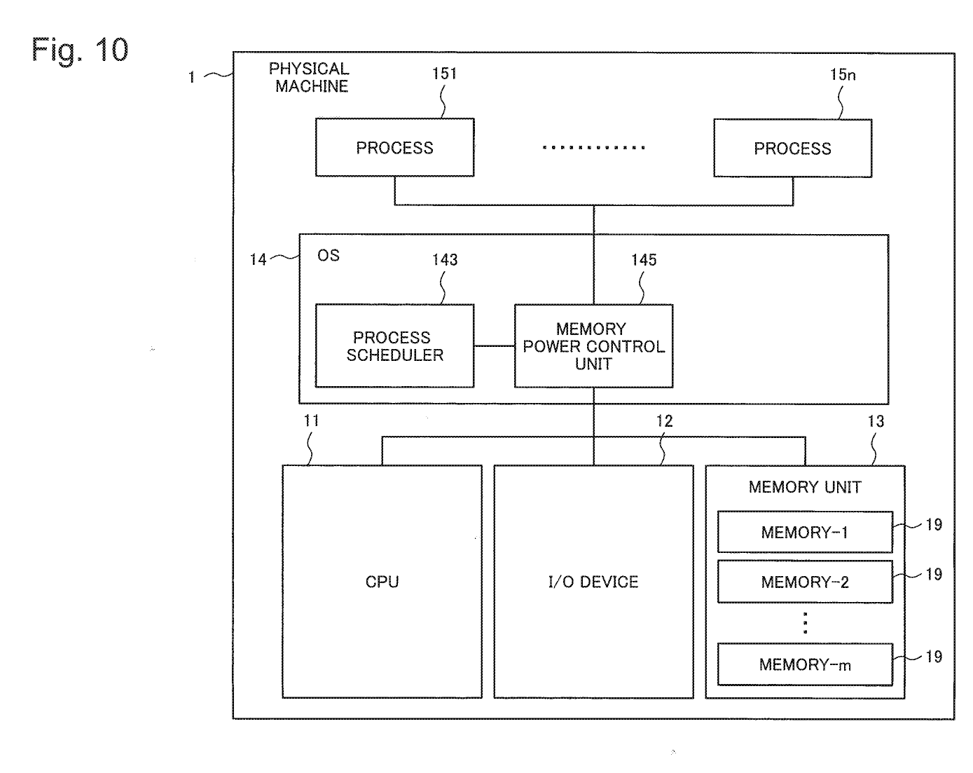

FIG. 10 is a block diagram illustrating a configuration of a power-saving control system for a server equipped with a non-volatile memory according to a fourteenth exemplary embodiment of the present invention. The power-saving control system according to the present exemplary embodiment includes a physical machine 1, and the physical machine 1 includes a CPU 11, an I/O device 12, and a memory unit 13. Further, the physical machine 1 includes an OS 14 that operates on the CPU 11, the I/O device 12, and the memory unit 13, and the OS 14 includes a process scheduler 143 and a memory power control unit 145. Further, processes 151 to 15n (where n is a positive integer) as applications operate on the OS 14.

The CPU 11 is a CPU that executes the OS 14 and the processes 151 to 15n.

The I/O device 12 includes an interface for data exchange with various devices such as a network.

The memory unit 13 includes one or more memories 19 (m memories in FIG. 10, where m is a positive integer). The memory 19 may be a non-volatile memory and power to an unused memory 19 can be shut off. In that case, stored data are not erased and the data can be read after power is resumed.

The memory unit 13 may also be a memory including one or more memory areas. In this case, a memory area corresponds to the memory 19.

As a non-volatile memory, an ReRAM, an MRAM, an STT-MRAM, a PRAM, an FeRAM, and the like may be used. Further, any non-volatile memory may be used without limiting to the memories described above.

The OS 14 includes the process scheduler 143 and the memory power control unit 145, and performs process execution control for an enhanced power-saving effect, by shutting off power to the memory 19 in the memory unit 13.

The process scheduler 143 performs scheduling of the processes 151 to 15n, notifies the memory power control unit 145 of a process 15i (where i is 1 to n) to be executed, and then executes the scheduled process 15i.

The memory power control unit 145 powers ON a memory 19 for the process 15i notified by the process scheduler 143, and, at the same time, powers OFF a memory 19 for a process in execution up to that point.

The power-saving control system according to the present exemplary embodiment powers ON a memory 19 for a process operating on the OS 14 and powers OFF a memory 19 for a remaining process not in execution, and therefore a power shut-off range of the memory unit 13 can be extended to provide an enhanced power-saving effect.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

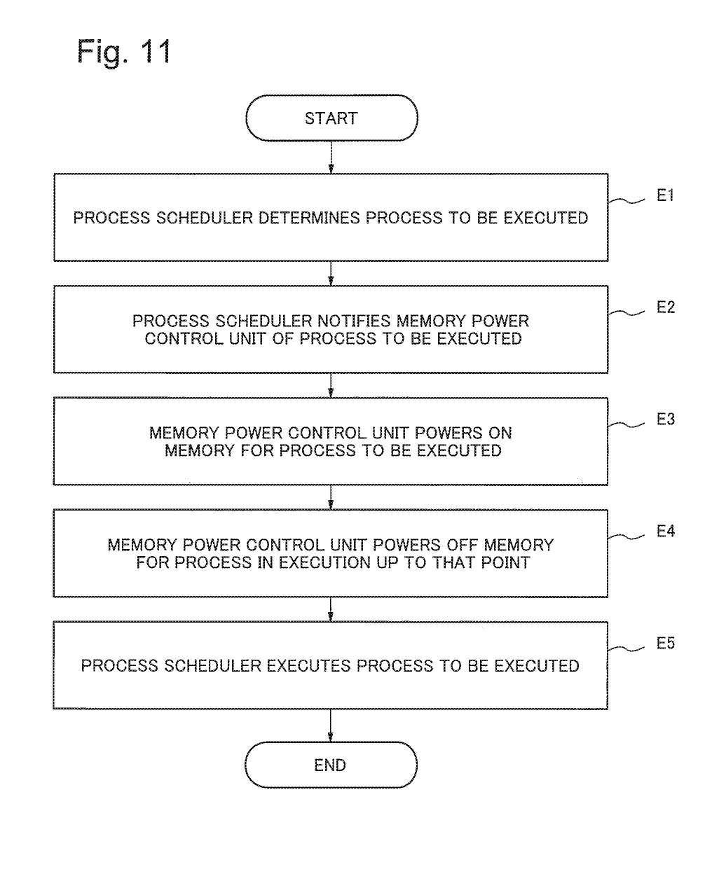

FIG. 11 is a flowchart illustrating a procedure of a power-saving control method of the power-saving control system according to the present exemplary embodiment illustrated in FIG. 10.

The process scheduler 143 determines a process 15i to be executed, out of the processes 151 to 15n operating on the physical machine 1 (Step E1). As for selection of a process 15i to be executed, a scheduling algorithm for a general scheduler is assumed without limiting to a specific algorithm.

As an algorithm for the process scheduler, a FIFO (First In, First Out) algorithm that executes processes in order of arrival at an executable queue, or a round robin algorithm that executes each process in a certain sequence, may be used. Further, a priority preemptive algorithm that executes processes for a certain time in order of priority may also be used. An algorithm for the process scheduler is not limited to the algorithms described above.

The process scheduler 143 notifies the memory power control unit 145 of the process 15i to be executed (Step E2).

The memory power control unit 145 powers ON a memory 19 to be operated for the process 15i (Step E3).

The memory power control unit 145 powers OFF a memory 19 operated for a process in execution up to that point (Step E4). At this time, when a memory 19 operated for a process in execution up to that point overlaps with a memory 19 operated for the process 15i to be executed, the memory 19 operated for the process in execution up to that point continues to be powered ON.

The process scheduler 143 executes the process 15i to be executed (Step E5).

A power-saving control device according to the present exemplary embodiment is a power-saving control device that has a configuration of the physical machine 1 in aforementioned FIG. 10. Further, a power-saving control program according to the present exemplary embodiment is a power-saving control program that causes execution of the flowchart in aforementioned FIG. 11.

The present exemplary embodiment provides the process execution control and the memory power control described above that power ON a memory for a process to be executed and power OFF a memory for a remaining process not in execution, and therefore a power shut-off range of a memory can be extended. Thus, an enhanced power-saving effect can be obtained.

As described above, the present exemplary embodiment is able to provide normally-off computing with an enhanced power-saving effect in a server equipped with a non-volatile memory.

### Fifteenth Exemplary Embodiment

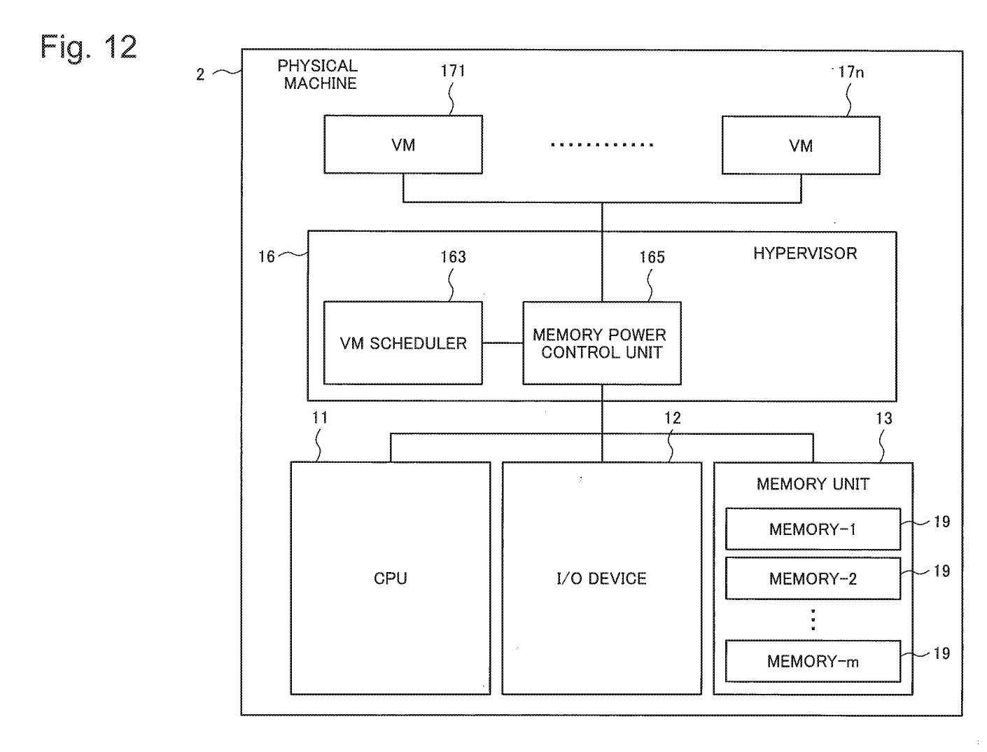

FIG. 12 is a block diagram illustrating a configuration of a power-saving control system according to a fifteenth exemplary embodiment of the present invention. The power-saving control system according to the present exemplary embodiment is a physical machine 2 obtained by virtualizing the interior of the physical machine 1 in FIG. 10 by a hypervisor 16, and is different from the power-saving system according to the fourteenth exemplary embodiment in that a plurality of virtual machines (VMs) 171 to 17n operate on the hypervisor 16. In FIG. 12, VMs operating on the hypervisor 16 are given reference signs 171 to 17n (where n is a positive integer) and distinguished.

In the present exemplary embodiment, a power shut-off range of the memory unit 13 can be extended to provide an enhanced power-saving effect, by powering ON a memory 19 for a VM in execution and powering OFF a memory 19 for a remaining VM not in execution.

Further, since the memory unit 13 uses a non-volatile memory 19, there is no need for saving data stored in the memory 19 into another memory, or restoring data saved in another memory to the memory 19, when powering OFF/ON the memory 19. Therefore, smooth normally-off computing with suppressed delay is provided.

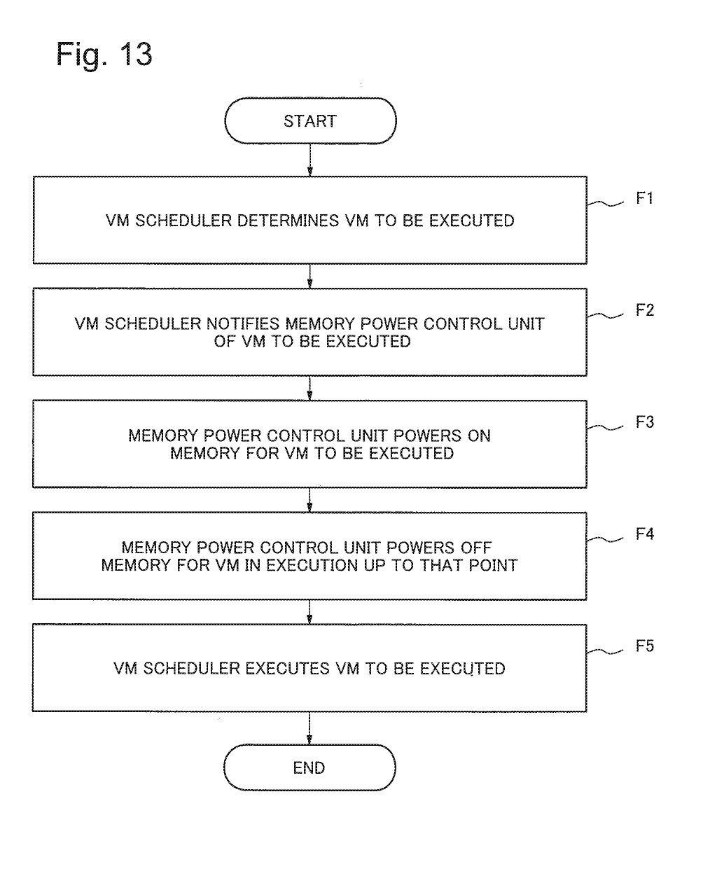

FIG. 13 is a flowchart illustrating a procedure of a power-saving control method of the power-saving control system according to the present exemplary embodiment illustrated in FIG. 12.

As illustrated in FIGS. 12 and 13, the VM scheduler 163 determines a VM 17i (where i is 1 to n) to be executed, out of the VMs 171 to 17n operating on the physical machine 2 (Step F1). As for selection of a VM 17i to be executed, a scheduling algorithm for a general VM scheduler is assumed without limiting to a specific algorithm.

As an algorithm for the VM scheduler, a FIFO algorithm that executes VMs in order of arrival at an executable queue, or a round robin algorithm that executes each VM in a certain sequence, may be used. Further, a priority preemptive algorithm that executes VMs for a certain time in order of priority may also be used. An algorithm for the VM scheduler is not limited to the algorithms described above.

The VM scheduler 163 notifies the memory power control unit 165 of the VM 17i to be executed (Step F2).

The memory power control unit 165 powers ON a memory 19 to be operated for the VM 17i (Step F3).

The memory power control unit 165 powers OFF a memory 19 operated for a VM in execution up to that point (Step F4). At this time, when a memory 19 operated for a VM in execution up to that point overlaps with a memory 19 operated for the VM 17i to be executed, the memory 19 operated for the VM in execution up to that point continues to be powered ON.

The VM scheduler 163 executes the VM 17i to be executed (Step F5).

A power-saving control device according to the present exemplary embodiment is a power-saving control device that has a configuration of the physical machine 2 in aforementioned FIG. 12. Further, a power-saving control program according to the present exemplary embodiment is a power-saving control program that causes execution of the flowchart in aforementioned FIG. 13.

The present exemplary embodiment provides the VM execution control and the memory power control described above that power ON a memory for a VM to be executed and power OFF a memory for a remaining VM not in execution, and therefore a power shut-off range of a memory can be extended. Thus, an enhanced power-saving effect can be obtained.

As described above, the present exemplary embodiment is able to provide normally-off computing with an enhanced power-saving effect in a server equipped with a non-volatile memory.

### Sixteenth Exemplary Embodiment

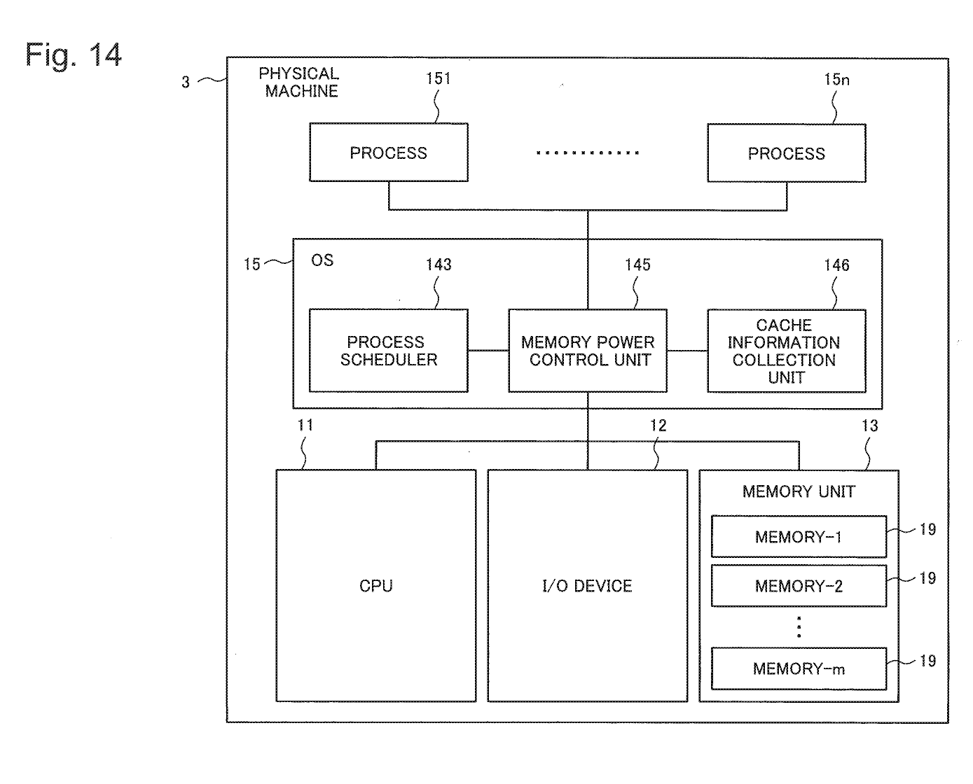

Next, a sixteenth exemplary embodiment of the present invention will be described. The sixteenth exemplary embodiment of the present invention has a configuration of a physical machine 3 illustrated in FIG. 14. The configuration of the physical machine 3 according to the present exemplary embodiment is different from the fourteenth exemplary embodiment in that the physical machine 3 includes an OS 15 obtained by adding a cache information collection unit 146 to the OS 14 illustrated in FIG. 10. The remaining configuration is the same as the fourteenth exemplary embodiment.

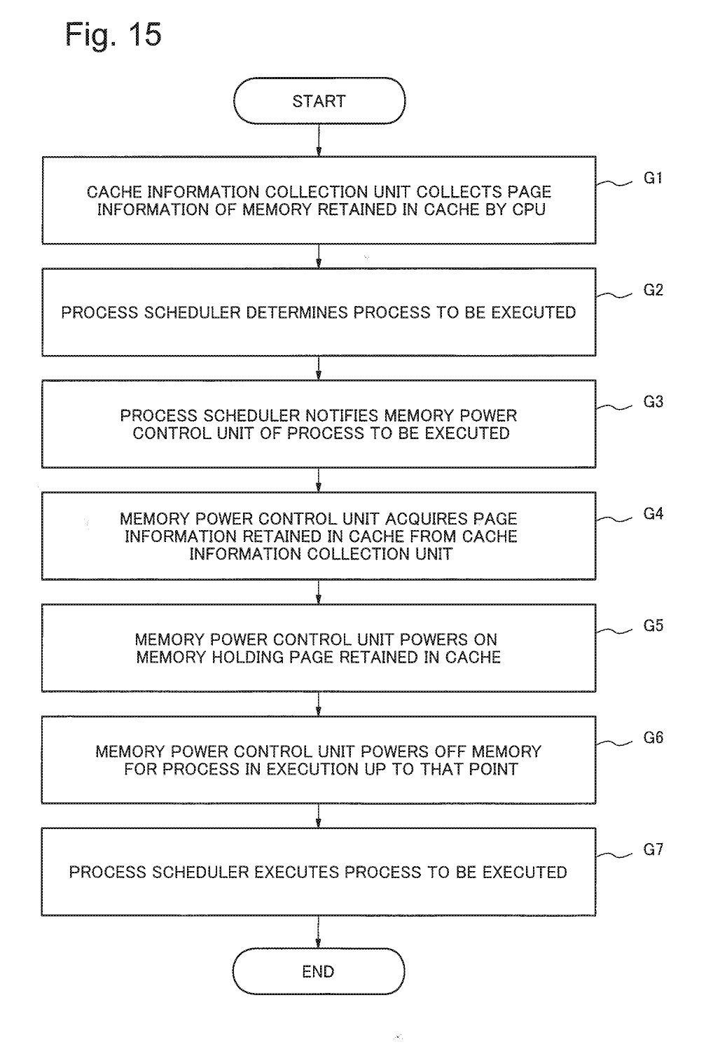

FIG. 15 is a flowchart illustrating a procedure of processing in a power-saving control system illustrated in FIG. 14.

The cache information collection unit 146 collects page information of a memory 19 retained in a cache by the CPU 11 (Step G1). It is assumed that the information is collected in synchronization with cache update.

The process scheduler 143 determines a process 15i (where i is 1 to n) to be executed, out of the processes 151 to 15n operating on the physical machine 3 (Step G2). As for selection of a process 15i to be executed, a scheduling algorithm for a general scheduler is assumed without limiting to a specific algorithm.

The process scheduler 143 notifies the memory power control unit 145 of the process 15i to be executed (Step G3).

The memory power control unit 145 acquires page information retained in a cache, with respect to a memory 19 to be operated for the process 15i, from the cache information collection unit 146 (Step G4).

The memory power control unit 145 powers ON a memory 19 that holds a page retained in the cache out of memories for the process 15i (Step G5).

The memory power control unit 145 powers OFF a memory 19 operated for a process in execution up to that point (Step G6). At this time, when a memory 19 operated for a process in execution up to that point overlaps with a memory 19 operated for the process 15i to be executed, the memory 19 operated for the process in execution up to that point continues to be powered ON.

The process scheduler 143 executes the process 15i to be executed (Step G7).

A power-saving control device according to the present exemplary embodiment is a power-saving control device that has a configuration of the physical machine 3 in aforementioned FIG. 14. Further, a power-saving control program according to the present exemplary embodiment is a power-saving control program that causes execution of the flowchart in aforementioned FIG. 15.

The present exemplary embodiment provides process execution control and memory power control that power ON a page retained in a cache out of memories for a process to be executed, and shut off power to a memory with a page not being cached and a memory for a remaining process not in execution. Therefore, a power shut-off range of a memory can be extended. Thus, an enhanced power-saving effect can be obtained.

As described above, the present exemplary embodiment is able to provide normally-off computing with an enhanced power-saving effect in a server equipped with a non-volatile memory.

### Seventeenth Exemplary Embodiment

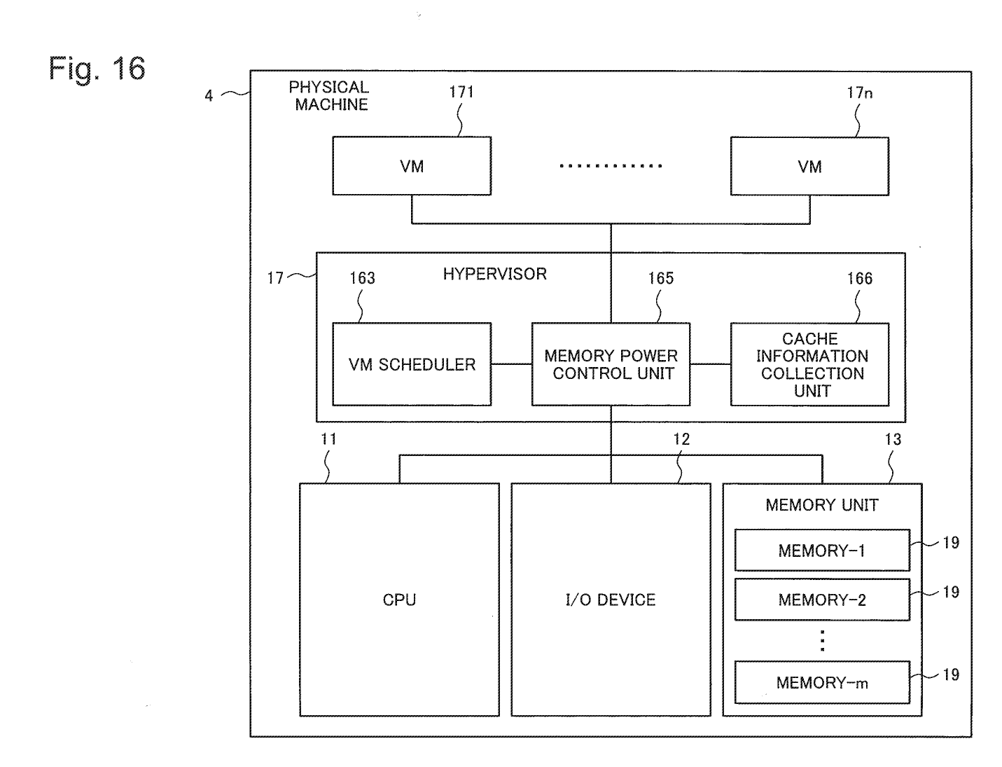

Next, a seventeenth exemplary embodiment of the present invention will be described. The seventeenth exemplary embodiment of the present invention has a configuration of a physical machine 4 illustrated in FIG. 16. The configuration of the physical machine 4 according to the present exemplary embodiment is different from the fifteenth exemplary embodiment in that the physical machine 4 includes a hypervisor 17 obtained by adding a cache information collection unit 166 to the hypervisor 16 illustrated in FIG. 12. The remaining configuration is the same as the fifteenth exemplary embodiment.

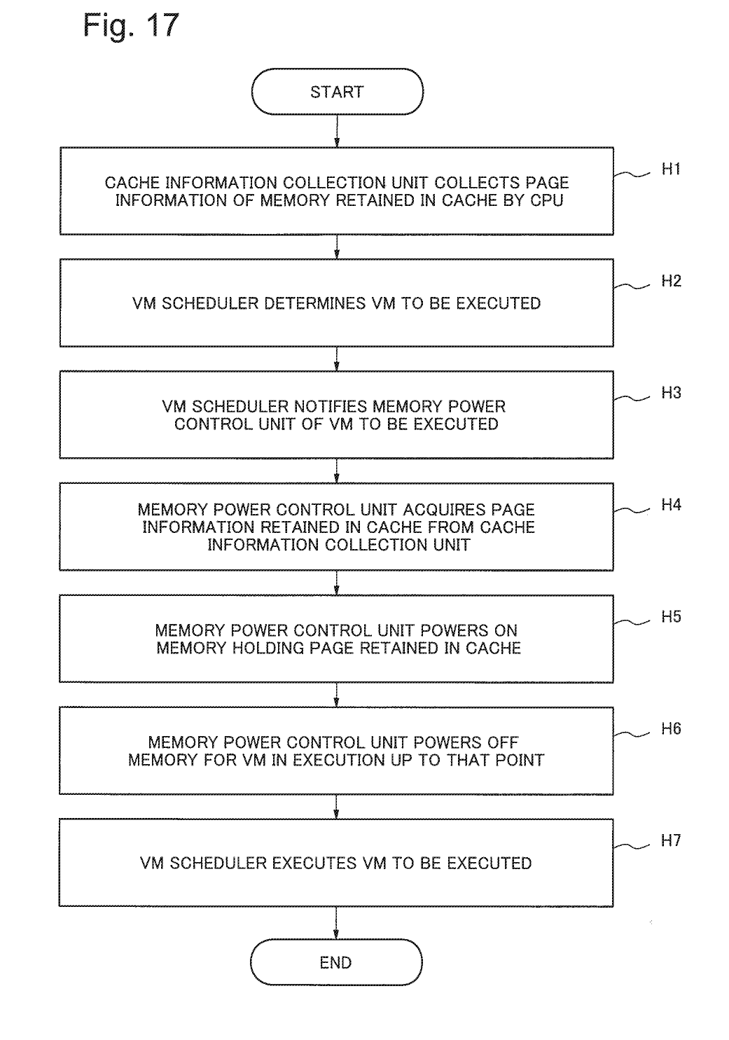

FIG. 17 is a flowchart illustrating a procedure of processing in a power-saving control system illustrated in FIG. 16.

The cache information collection unit 166 collects page information of a memory 19 retained in a cache by the CPU 11 (Step H1). It is assumed that the information is collected in synchronization with cache update.

The VM scheduler 163 determines a VM 17i (where i is 1 to n) to be executed, out of the VMs 171 to 17n operating on the physical machine 4 (Step H2). As for selection of a VM 17i to be executed, a scheduling algorithm for a general VM scheduler is assumed without limiting to a specific algorithm.

The VM scheduler 163 notifies the memory power control unit 165 of the VM 17i to be executed (Step H3).

The memory power control unit 165 acquires page information retained in a cache, with respect to a memory 19 to be operated in the VM 17i, from the cache information collection unit 166 (Step H4).

The memory power control unit 165 powers ON a memory 19 that holds a page retained in the cache out of memories for the VM 17i (Step H5).

The memory power control unit 165 powers OFF a memory 19 operated for a VM in execution up to that point (Step H6). At this time, when a memory 19 operated for a VM in execution up to that point overlaps with a memory 19 operated for the VM 15i to be executed, the memory 19 operated for the VM in execution up to that point continues to be powered ON.

The VM scheduler 163 executes the VM 17i to be executed (Step H7).

A power-saving control device according to the present exemplary embodiment is a power-saving control device that has a configuration of the physical machine 4 in aforementioned FIG. 16. Further, a power-saving control program according to the present exemplary embodiment is a power-saving control program that causes execution of the flowchart in aforementioned FIG. 17.

The present exemplary embodiment provides VM execution control and memory power control that power ON a page retained in a cache out of memories for a VM to be executed, and shut off power to a memory with a page not being cached and a memory for a remaining VM not in execution. Therefore, a power shut-off range of a memory can be extended. Thus, an enhanced power-saving effect can be obtained.

As described above, the present exemplary embodiment is able to provide normally-off computing with an enhanced power-saving effect in a server equipped with a non-volatile memory.

### Eighteenth Exemplary Embodiment

Next, an eighteenth exemplary embodiment of the present invention will be described. The eighteenth exemplary embodiment of the present invention has a configuration of the physical machine 3 in FIG. 14, similar to the sixteenth exemplary embodiment.

In the physical machine 3 according to the sixteenth exemplary embodiment illustrated in FIG. 14, the cache information collection unit 146 collects page information of a memory 19 retained in a cache by the CPU 11 (Step G1). Further, the memory power control unit 145 acquires page information retained in a cache, with respect to a memory 19 to be operated for the process 15i, from the cache information collection unit 146 (Step G4). Further, the memory power control unit 145 powers ON a memory 19 that holds a page retained in the cache out of memories for the process 15i (Step G5), and powers OFF a memory 19 operated for a process in execution up to that point (Step G6).

On the other hand, in the physical machine 3 according to the present exemplary embodiment illustrated in FIG. 14, the cache information collection unit 146 collects a read/write ratio of a cache in the CPU 11. Further, the memory power control unit 145 acquires information about a read/write ratio of a cache in the CPU 11, with respect to a memory 19 to be operated for the process 15i, from the cache information collection unit 146. Further, when a ratio of write in a read/write ratio of a cache in the CPU 11, with respect to a memory for the process 15i, becomes lower than a threshold, the memory power control unit 145 powers OFF the memory 19 corresponding to the cache.

The remaining operation of the present exemplary embodiment is the same as the sixteenth exemplary embodiment.

As described above, the present exemplary embodiment is able to provide normally-off computing with an enhanced power-saving effect in a server equipped with a non-volatile memory.

### Nineteenth Exemplary Embodiment

Next, a nineteenth exemplary embodiment of the present invention will be described. The nineteenth exemplary embodiment of the present invention has a configuration of the physical machine 4 in FIG. 16, similar to the seventeenth exemplary embodiment.

In the physical machine 4 according to the seventeenth exemplary embodiment illustrated in FIG. 16, the cache information collection unit 166 collects page information of a memory 19 retained in a cache by the CPU 11 (Step H1). Further, the memory power control unit 165 acquires page information retained in a cache, with respect to a memory 19 to be operated for the VM 17i, from the cache information collection unit 166 (Step H4). Further, the memory power control unit 165 powers ON a memory 19 that holds a page retained in the cache out of memories for the VM 17i (Step H5), and powers OFF a memory 19 operated for a VM in execution up to that point (Step H6).

On the other hand, in the physical machine 4 according to the present exemplary embodiment illustrated in FIG. 16, the cache information collection unit 166 collects a read/write ratio of a cache in the CPU 11. Further, the memory power control unit 165 acquires information about a read/write ratio of a cache in the CPU 11, with respect to a memory 19 to be operated for the VM 15i, from the cache information collection unit 166. Further, when a ratio of write in a read/write ratio of a cache in the CPU 11, with respect to a memory for the VM 17i, becomes lower than a threshold, the memory power control unit 165 powers OFF the memory 19 corresponding to the cache.

The remaining operation of the present exemplary embodiment is the same as the seventeenth exemplary embodiment.

As described above, the present exemplary embodiment is able to provide normally-off computing with an enhanced power-saving effect in a server equipped with a non-volatile memory.

The aforementioned exemplary embodiments may also be described in whole or part as the following Supplementary Notes but are not limited thereto.

### (Supplementary Note 1)

A power-saving control system including a physical machine that includes a memory and a CPU including a plurality of CPU cores, an operating system that operates on the physical machine, and one or more processes that operate on the operating system, wherein the operating system includes a process characteristic collection unit that collects a characteristic of the process, a core allocation determination unit that determines allocation of the CPU core to the process, in accordance with the characteristic of the process, and a process scheduler that executes the process, in accordance with the allocation, and powers OFF/ON the CPU core or the memory, in accordance with execution of the process.

### (Supplementary Note 2)

The power-saving control system according to Supplementary Note 1, wherein the memory is a non-volatile memory.

### (Supplementary Note 3)

The power-saving control system according to Supplementary Note 1 or 2, wherein the characteristic of the process is a load characteristic of the process or a resource utilization characteristic.

### (Supplementary Note 4)

The power-saving control system according to Supplementary Note 3, wherein the load characteristic of the process is a CPU utilization rate, a cache hit rate, or context switching frequency.

### (Supplementary Note 5)

The power-saving control system according to Supplementary Note 3, wherein the resource utilization characteristic is incoming/outgoing network traffic.

### (Supplementary Note 6)

The power-saving control system according to Supplementary Note 4, wherein the core allocation determination unit performs allocation to the CPU core in descending order of the CPU utilization rate.

### (Supplementary Note 7)

The power-saving control system according to Supplementary Note 4, wherein the core allocation determination unit performs allocation to the CPU core so as to level the CPU utilization rate.

### (Supplementary Note 8)

The power-saving control system according to Supplementary Note 4, wherein the core allocation determination unit performs allocation to the CPU core in descending order of the context switching frequency.

### (Supplementary Note 9)

The power-saving control system according to Supplementary Note 4, wherein the core allocation determination unit performs allocation to the CPU core so as to level the context switching frequency.

### (Supplementary Note 10)

The power-saving control system according to any one of Supplementary Notes 1 to 9, wherein the operating system is a hypervisor, and the process is a virtual machine.

### (Supplementary Note 11)

A power-saving control device including a physical machine that includes a memory and a CPU including a plurality of CPU cores, an operating system unit that operates on the physical machine, and one or more process units that are operated by the operating system unit, wherein the operating system unit includes a process characteristic collection unit that collects a characteristic of the process unit, a core allocation determination unit that determines allocation of the CPU core to the process unit, in accordance with the characteristic of the process unit, and a process scheduler that executes the process unit, in accordance with the allocation, and powers OFF/ON the CPU core or the memory, in accordance with execution of the process unit.

### (Supplementary Note 12)

The power-saving control device according to Supplementary Note 11, wherein the memory is a non-volatile memory.

### (Supplementary Note 13)

The power-saving control device according to Supplementary Note 11 or 12, wherein the characteristic of the process unit is a load characteristic of the process unit or a resource utilization characteristic.

### (Supplementary Note 14)

The power-saving control device according to Supplementary Note 13, wherein the load characteristic of the process unit is a CPU utilization rate, a cache hit rate, or context switching frequency.

### (Supplementary Note 15)

The power-saving control device according to Supplementary Note 13, wherein the resource utilization characteristic is incoming/outgoing network traffic.

### (Supplementary Note 16)

The power-saving control device according to Supplementary Note 14, wherein the core allocation determination unit performs allocation to the CPU core in descending order of the CPU utilization rate.

### (Supplementary Note 17)

The power-saving control device according to Supplementary Note 14, wherein the core allocation determination unit performs allocation to the CPU core so as to level the CPU utilization rate.

### (Supplementary Note 18)

The power-saving control device according to Supplementary Note 14, wherein the core allocation determination unit performs allocation to the CPU core in descending order of the context switching frequency.

### (Supplementary Note 19)

The power-saving control device according to Supplementary Note 14, wherein the core allocation determination unit performs allocation to the CPU core so as to level the context switching frequency.

### (Supplementary Note 20)

The power-saving control device according to any one of Supplementary Notes 11 to 19, wherein the operating system unit is a hypervisor, and the process unit is a virtual machine.

### (Supplementary Note 21)

A power-saving control method of a power-saving control system that includes a physical machine including a memory and a CPU including a plurality of CPU cores, an operating system operating on the physical machine, and one or more processes operating on the operating system, wherein the operating system collects a characteristic of the process, determines allocation of the CPU core to the process, in accordance with the characteristic of the process, executes the process, in accordance with the allocation, and powers OFF/ON the CPU core or the memory, in accordance with execution of the process.

### (Supplementary Note 22)

The power-saving control method according to Supplementary Note 21, wherein the memory is a non-volatile memory.

### (Supplementary Note 23)

The power-saving control method according to Supplementary Note 21 or 22, wherein the characteristic of the process is a load characteristic of the process or a resource utilization characteristic.

### (Supplementary Note 24)

The power-saving control method according to Supplementary Note 23 wherein the load characteristic of the process is a CPU utilization rate, a cache hit rate, or context switching frequency.

### (Supplementary Note 25)

The power-saving control method according to Supplementary Note 23, wherein the resource utilization characteristic is incoming/outgoing network traffic.

### (Supplementary Note 26)

The power-saving control method according to Supplementary Note 24, wherein the determination of core allocation is allocation to the CPU core performed in descending order of the CPU utilization rate.

### (Supplementary Note 27)

The power-saving control method according to Supplementary Note 24, wherein the determination of core allocation is allocation to the CPU core performed so as to level the CPU utilization rate.

### (Supplementary Note 28)

The power-saving control method according to Supplementary Note 24, wherein the determination of core allocation is allocation to the CPU core performed in descending order of the context switching frequency.

### (Supplementary Note 29)

The power-saving control method according to Supplementary Note 24, wherein the determination of core allocation is allocation to the CPU core performed so as to level the context switching frequency.

### (Supplementary Note 30)

The power-saving control method according to any one of Supplementary Notes 21 to 29, wherein the operating system is a hypervisor, and the process is a virtual machine.

### (Supplementary Note 31)

A power-saving control program of a power-saving control system that includes a physical machine including a memory and a CPU including a plurality of CPU cores, an operating system operating on the physical machine, and one or more processes operating on the operating system, the program causing the operating system to execute processing of collecting a characteristic of the process, processing of determining allocation of the CPU core to the process, in accordance with the characteristic of the process, processing of executing the process, in accordance with the allocation, and processing of powering OFF/ON the CPU core or the memory, in accordance with execution of the process.

### (Supplementary Note 32)

The power-saving control program according to Supplementary Note 31, wherein the memory is a non-volatile memory.

### (Supplementary Note 33)

The power-saving control program according to Supplementary Note 31 or 32, wherein the characteristic of the process is a load characteristic of the process or a resource utilization characteristic.

### (Supplementary Note 34)

The power-saving control program according to Supplementary Note 33, wherein the load characteristic of the process is a CPU utilization rate, a cache hit rate, or context switching frequency.

### (Supplementary Note 35)

The power-saving control program according to Supplementary Note 33, wherein the resource utilization characteristic is incoming/outgoing network traffic.

### (Supplementary Note 36)

The power-saving control program according to Supplementary Note 34, wherein the processing of determining allocation of the core is allocation to the CPU core performed in descending order of the CPU utilization rate.

### (Supplementary Note 37)

The power-saving control program according to Supplementary Note 34, wherein the processing of determining allocation of the core is allocation to the CPU core performed so as to level the CPU utilization rate.

### (Supplementary Note 38)

The power-saving control program according to Supplementary Note 34, wherein the processing of determining allocation of the core is allocation to the CPU core performed in descending order of the context switching frequency.

### (Supplementary Note 39)

The power-saving control program according to Supplementary Note 34, wherein the processing of determining allocation of the core is allocation to the CPU core performed so as to level the context switching frequency.

### (Supplementary Note 40)

The power-saving control program according to any one of Supplementary Notes 31 to 39, wherein the operating system is a hypervisor, and the process is a virtual machine.

### (Supplementary Note 41)

A power-saving control system including a physical machine that includes a memory and a CPU including a plurality of CPU cores, an operating system that operates on the physical machine, and one or more processes that operate on the operating system, wherein the operating system includes a process characteristic collection unit that collects a load characteristic of the process or an interrupt characteristic of the process, an interrupt coalescing unit that coalesces interrupts to the process, in accordance with the load characteristic or the interrupt characteristic, and a process scheduler that executes interrupts in accordance with coalescing of the interrupts, and powers OFF/ON the CPU core or the memory, in accordance with execution of the interrupt.

### (Supplementary Note 42)

The power-saving control system according to Supplementary Note 41, wherein the memory is a non-volatile memory.

### (Supplementary Note 43)

The power-saving control system according to Supplementary Note 41 or 42, wherein the load characteristic is a CPU utilization rate, a cache hit rate, or context switching frequency.

### (Supplementary Note 44)

The power-saving control system according to any one of Supplementary Notes 41 to 43, wherein the interrupt characteristic is frequency of interrupts caused by input/output from/to a device or priority of the process.

### (Supplementary Note 45)

The power-saving control system according to any one of Supplementary Notes 41 to 44, wherein the interrupt coalescing unit coalesces interrupts to a process with a low value of the load characteristic or the interrupt characteristic.

### (Supplementary Note 46)

The power-saving control system according to any one of Supplementary Notes 41 to 45, wherein the operating system is a hypervisor, and the process is a virtual machine.

### (Supplementary Note 47)

A power-saving control device including a physical machine that includes a memory and a CPU including a plurality of CPU cores, an operating system unit that operates on the physical machine, and one or more process units that operate on the operating system, wherein the operating system unit includes a process characteristic collection unit that collects a load characteristic of the process unit or an interrupt characteristic of the process unit, an interrupt coalescing unit that coalesces interrupts to the process unit, in accordance with the load characteristic or the interrupt characteristic, and a process scheduler that executes interrupts, in accordance with coalescing of the interrupts, and powers OFF/ON the CPU core or the memory, in accordance with execution of the interrupt.

### (Supplementary Note 48)

The power-saving control device according to Supplementary Note 47, wherein the memory is a non-volatile memory.

### (Supplementary Note 49)

The power-saving control device according to Supplementary Note 47 or 48, wherein the load characteristic is a CPU utilization rate, a cache hit rate, or context switching frequency.

### (Supplementary Note 50)

The power-saving control device according to any one of Supplementary Notes 47 to 49, wherein the interrupt characteristic is frequency of interrupts caused by input/output from/to a device or priority of the process.

### (Supplementary Note 51)

The power-saving control device according to any one of Supplementary Notes 47 to 50, wherein the interrupt coalescing unit coalesces interrupts to a process unit with a low value of the load characteristic or the interrupt characteristic.

### (Supplementary Note 52)

The power-saving control device according to any one of Supplementary Notes 47 to 51, wherein the operating system unit is a hypervisor, and the process unit is a virtual machine.

### (Supplementary Note 53)

A power-saving control method of a power-saving control system that includes a physical machine including a memory and a CPU including a plurality of CPU cores, an operating system that operates on the physical machine, and one or more processes that operate on the operating system, wherein the operating system collects a load characteristic of the process or an interrupt characteristic of the process, coalesces interrupts to the process, in accordance with the load characteristic or the interrupt characteristic, executes interrupts, in accordance with coalescing of the interrupts, and powers OFF/ON the CPU core or the memory, in accordance with execution of the interrupt.

### (Supplementary Note 54)

The power-saving control method according to Supplementary Note 53, wherein the memory is a non-volatile memory.

### (Supplementary Note 55)

The power-saving control method according to Supplementary Note 53 or 54, wherein the load characteristic is a CPU utilization rate, a cache hit rate, or context switching frequency.

### (Supplementary Note 56)

The power-saving control method according to any one of Supplementary Notes 53 to 55, wherein the interrupt characteristic is frequency of interrupts caused by input/output from/to a device or priority of the process.

### (Supplementary Note 57)

The power-saving control method according to any one of Supplementary Notes 53 to 56, wherein the interrupt coalescing coalesces interrupts to a process with a low value of the load characteristic or the interrupt characteristic.

### (Supplementary Note 58)

The power-saving control method according to any one of Supplementary Notes 53 to 57, wherein the operating system is a hypervisor, and the process is a virtual machine.

### (Supplementary Note 59)

A power-saving control program of a power-saving control system that includes a physical machine including a memory and a CPU including a plurality of CPU cores, an operating system operating on the physical machine, and one or more processes operating on the operating system, the program causing the operating system to execute processing of collecting a load characteristic of the process or an interrupt characteristic of the process, processing of coalescing interrupts to the process, in accordance with the load characteristic or the interrupt characteristic, processing of executing an interrupt, in accordance with coalescing of the interrupts, and processing of powering OFF/ON the CPU core or the memory, in accordance with execution of the interrupt.

### (Supplementary Note 60)

The power-saving control program according to Supplementary Note 59, wherein the memory is a non-volatile memory.

### (Supplementary Note 61)

The power-saving control program according to Supplementary Note 59 or 60, wherein the load characteristic is a CPU utilization rate, a cache hit rate, or context switching frequency.

### (Supplementary Note 62)

The power-saving control program according to any one of Supplementary Notes 59 to 61, wherein the interrupt characteristic is frequency of interrupts caused by input/output from/to a device or priority of the process.

### (Supplementary Note 63)

The power-saving control program according to any one of Supplementary Notes 59 to 62, wherein the processing of coalescing interrupts coalesces interrupts to a process with a low value of the load characteristic or the interrupt characteristic.

### (Supplementary Note 64)

The power-saving control program according to any one of Supplementary Notes 59 to 63, wherein the operating system is a hypervisor, and the process is a virtual machine.

### (Supplementary Note 65)

A power-saving control system including a physical machine that includes a CPU and a memory, an operating system that operates on the physical machine, and one or more processes that operate on the operating system, wherein the operating system includes a process scheduler that performs scheduling of the process, and a memory power control unit that powers ON/OFF the memory, in accordance with the scheduling.

### (Supplementary Note 66)

The power-saving control system according to Supplementary Note 65, wherein the memory is a non-volatile memory.

### (Supplementary Note 67)

The power-saving control system according to Supplementary Note 65 or 66, wherein the process scheduler executes the process, in accordance with the scheduling.

### (Supplementary Note 68)

The power-saving control system according to any one of Supplementary Notes 65 to 67, wherein the memory power control unit powers ON the memory related to the process executed by the process scheduler.

### (Supplementary Note 69)

The power-saving control system according to any one of Supplementary Notes 65 to 68, wherein the memory power control unit powers OFF the memory other than the memory related to the process executed by the process scheduler.

### (Supplementary Note 70)

The power-saving control system according to any one of Supplementary Notes 65 to 69, wherein the operating system includes a cache information collection unit that collects page information of a memory retained in a cache by the CPU, and the memory power control unit acquires the page information from the cache information collection unit, and powers ON the memory, in accordance with the page information.

### (Supplementary Note 71)

The power-saving control system according to any one of Supplementary Notes 65 to 70, wherein the operating system is a hypervisor, and the process is a virtual machine.

### (Supplementary Note 72)

A power-saving control device including a physical machine that includes a CPU and a memory, an operating system unit that operates on the physical machine, and one or more process units operated by the operating system unit, wherein the operating system unit includes a process scheduler that performs scheduling of the process unit, and a memory power control unit that powers ON/OFF the memory, in accordance with the scheduling.

### (Supplementary Note 73)

The power-saving control device according to Supplementary Note 72, wherein the memory is a non-volatile memory.

### (Supplementary Note 74)

The power-saving control device according to Supplementary Note 72 or 73, wherein the process scheduler executes the process unit, in accordance with the scheduling.

### (Supplementary Note 75)

The power-saving control device according to any one of Supplementary Notes 72 to 74, wherein the memory power control unit powers ON the memory related to the process unit executed by the process scheduler.

### (Supplementary Note 76)

The power-saving control device according to any one of Supplementary Notes 72 to 75, wherein the memory power control unit powers OFF the memory other than the memory related to the process unit executed by the process scheduler.

### (Supplementary Note 77)

The power-saving control device according to any one of Supplementary Notes 72 to 76, wherein the operating system unit includes a cache information collection unit that collects page information of a memory retained in a cache by the CPU, and the memory power control unit acquires the page information from the cache information collection unit, and powers ON the memory, in accordance with the page information.

### (Supplementary Note 78)

The power-saving control device according to any one of Supplementary Notes 72 to 77, wherein the operating system unit is a hypervisor, and the process unit is a virtual machine.

### (Supplementary Note 79)

A power-saving control method of a power-saving control system that includes a physical machine including a CPU and a memory, an operating system operating on the physical machine, and one or more processes operating on the operating system, wherein the operating system performs scheduling of the process, and powers ON/OFF the memory, in accordance with the scheduling.

### (Supplementary Note 80)

The power-saving control method according to Supplementary Note 79, wherein the memory is a non-volatile memory.

### (Supplementary Note 81)

The power-saving control method according to Supplementary Note 79 or 80, wherein the scheduling of the process executes the process, in accordance with the scheduling.

### (Supplementary Note 82)

The power-saving control method according to any one of Supplementary Notes 79 to 81, wherein powering ON/OFF of the memory powers ON the memory related to the process executed in accordance with the scheduling.

### (Supplementary Note 83)

The power-saving control method according to any one of Supplementary Notes 79 to 82, wherein powering ON/OFF of the memory powers OFF the memory other than the memory related to the process executed in accordance with the scheduling.

### (Supplementary Note 84)

The power-saving control method according to any one of Supplementary Notes 79 to 83, wherein the operating system collects page information of a memory retained in a cache by the CPU, and power control of the memory acquires the page information, and powers ON the memory, in accordance with the page information.

### (Supplementary Note 85)

The power-saving control method according to any one of Supplementary Notes 79 to 84, wherein the operating system is a hypervisor, and the process is a virtual machine.

### (Supplementary Note 86)

A power-saving control program of a power-saving control system that includes a physical machine including a CPU and a memory, an operating system operating on the physical machine, and one or more processes operating on the operating system, the program causing the operating system to execute processing of scheduling the process, and processing of powering ON/OFF the memory, in accordance with the scheduling.

### (Supplementary Note 87)

The power-saving control program according to Supplementary Note 86, wherein the memory is a non-volatile memory.

### (Supplementary Note 88)

The power-saving control program according to Supplementary Note 86 or 87, wherein processing of scheduling the process executes the process, in accordance with the scheduling.

### (Supplementary Note 89)

The power-saving control program according to any one of Supplementary Notes 86 to 88, wherein processing of powering ON/OFF the memory powers ON the memory related to the process executed in accordance with the scheduling.

### (Supplementary Note 90)

The power-saving control program according to any one of Supplementary Notes 86 to 89, wherein processing of powering ON/OFF the memory powers OFF the memory other than the memory related to the process executed in accordance with the scheduling.

### (Supplementary Note 91)

The power-saving control program according to any one of Supplementary Notes 86 to 90, further causing the operating system to execute processing of collecting page information of a memory retained in a cache by the CPU, wherein processing of powering ON/OFF the memory acquires the page information, and powers ON the memory, in accordance with the page information.

### (Supplementary Note 92)

The power-saving control program according to any one of Supplementary Notes 86 to 91, wherein the operating system is a hypervisor, and the process is a virtual machine.

The present invention is not limited to the aforementioned exemplary embodiments and may be modified in various ways within the scope of the invention described in CLAIMS, and such modifications are also included in the scope of the invention.

This application claims priority based on Japanese Patent Application No. 2013-161302 filed on Aug. 2, 2013, Japanese Patent Application No. 2013-161303 filed on Aug. 2, 2013, and Japanese Patent Application No. 2013-161304 filed on Aug. 2, 2013, the disclosure of which is hereby incorporated by reference thereto in its entirety.

### INDUSTRIAL APPLICABILITY

The present invention is available as a technology enhancing a power-saving effect in a normally-off computing technology in a server equipped with a non-volatile memory.

### REFERENCE SIGNS LIST

1, 2, 3, 4 Physical machine
11 CPU
12 I/O device
13 Memory unit
14, 15 OS
141 Process characteristic collection unit
142 Core allocation determination unit
143 Process scheduler
144 Interrupt coalescing unit
145 Memory power control unit
146 Cache information collection unit
150, 151 to 15n Process
16, 17 Hypervisor
161 VM characteristic collection unit
162 Core allocation determination unit
163 VM scheduler
164 Interrupt coalescing unit
165 Memory power control unit
166 Cache information collection unit
171 to 17n Virtual machine (VM)
18 CPU core
19 Memory

What is claimed is:

1. A power-saving control system comprising: a physical machine that includes a memory and a CPU including a plurality of CPU cores; an operating system that operates on the physical machine; and one or more processes that operate on the operating system, wherein the operating system includes a process characteristic collection unit that collects a characteristic of the process, a core allocation determination unit that determines allocation of the CPU core to the process, in accordance with a characteristic of the process, and a process scheduler that executes the process, in accordance with the allocation, and powers OFF/ON the CPU core or the memory, in accordance with execution of the process.

2. The power-saving control system according to claim 1, wherein the memory is a non-volatile memory.

3. The power-saving control system according to claim 1, wherein a characteristic of the process is a load characteristic of the process or a resource utilization characteristic.

4. The power-saving control system according to claim 3, wherein a load characteristic of the process is a CPU utilization rate, a cache hit rate, or context switching frequency.

5. The power-saving control system according to claim 4, wherein the core allocation determination unit performs allocation to the CPU core in descending order of the CPU utilization rate.

6. The power-saving control system according to claim 4, wherein the core allocation determination unit performs allocation to the CPU core in descending order of the context switching frequency.

7. The power-saving control system according to claim 1, wherein the operating system is a hypervisor, and the process is a virtual machine.

8. A power-saving control device comprising: a physical machine that includes a memory and a CPU including a plurality of CPU cores; an operating system unit that operates on the physical machine; and one or more process units that are operated by the operating system unit, wherein the operating system unit includes a process characteristic collection unit that collects a characteristic of the process unit, a core allocation determination unit that determines allocation of the CPU core to the process unit, in accordance with a characteristic of the process unit, and a process scheduler that executes the process unit, in accordance with the allocation, and powers OFF/ON the CPU core or the memory, in accordance with execution of the process unit.

9. A power-saving control method of a power-saving control system that includes a physical machine including a memory and a CPU including a plurality of CPU cores, an operating system operating on the physical machine, and one or more processes operating on the operating system, wherein the operating system collects a characteristic of the process, determines allocation of the CPU core to the process, in accordance with a characteristic of the process, executes the process, in accordance with the allocation, and powers OFF/ON the CPU core or the memory, in accordance with execution of the process.

10. A recording medium recording a power-saving control program of a power-saving control system that includes a physical machine including a memory and a CPU including a plurality of CPU cores, an operating system operating on the physical machine, and one or more processes operating on the operating system, the program causing the operating system to execute: processing of collecting a characteristic of the process; processing of determining allocation of the CPU core to the process, in accordance with a characteristic of the process; processing of executing the process, in accordance with the allocation; and processing of powering OFF/ON the CPU core or the memory, in accordance with execution of the process.

11. The power-saving control system according to claim 3, wherein the resource utilization characteristic is incoming/outgoing network traffic.

12. The power-saving control system according to claim 4, wherein the core allocation determination unit performs allocation to the CPU core so as to level the CPU utilization rate.

13. The power-saving control system according to claim 4, wherein the core allocation determination unit performs allocation to the CPU core so as to level the context switching frequency.

14. A power-saving control system comprising: a physical machine that includes a memory and a CPU including a plurality of CPU cores; an operating system that operates on the physical machine; and one or more processes that operate on the operating system, wherein the operating system includes a process characteristic collection unit that collects a load characteristic of the process or an interrupt characteristic of the process, an interrupt coalescing unit that coalesces interrupts to the process, in accordance with the load characteristic or the interrupt characteristic, and a process scheduler that executes interrupts in accordance with coalescing of the interrupts, and powers OFF/ON the CPU core or the memory in accordance with execution of the interrupt.

15. The power-saving control system according to claim 14, wherein the memory is a non-volatile memory.

16. The power-saving control system according to claim 14, wherein the load characteristic is a CPU utilization rate, a cache hit rate, or context switching frequency.

17. The power-saving control system according to claim 14, wherein the interrupt characteristic is frequency of interrupts caused by input/output from/to a device or priority of the process.

18. The power-saving control system according to claim 14, wherein the interrupt coalescing unit coalesces interrupts to a process with a low value of the load characteristic or the interrupt characteristic.

19. The power-saving control system according to claim 14, wherein the operating system is a hypervisor, and the process is a virtual machine.

20. A power-saving control system comprising: a physical machine that includes a CPU and a memory; an operating system that operates on the physical machine; and one or more processes that operate on the operating system, wherein the operating system includes a process scheduler that performs scheduling of the process, and a memory power control unit that powers ON/OFF the memory, in accordance with the scheduling.

21. The power-saving control system according to claim 20, wherein the memory is a non-volatile memory.

22. The power-saving control system according to claim 20, wherein the process scheduler executes the process, in accordance with the scheduling.

23. The power-saving control system according to claim 20, wherein the memory power control unit powers ON the memory related to the process executed by the process scheduler.

24. The power-saving control system according to claim 20, wherein the memory power control unit powers OFF the memory other than the memory related to the process executed by the process scheduler.

25. The power-saving control system according to claim 20, wherein the operating system includes a cache information collection unit that collects page information of a memory retained in a cache by the CPU, and the memory power control unit acquires the page information from the cache information collection unit and powers ON the memory, in accordance with the page information.

26. The power-saving control system according to claim 20, wherein the operating system is a hypervisor, and the process is a virtual machine.
